(19) United States
(12) Patent Application Publication
(10) Pub. No.: US 2015/0116247 A1
(43) Pub. Date: Apr. 30, 2015

(54) INPUT DEVICE AND DISPLAY DEVICE

(71) Applicant: Panasonic Intellectual Property Management Co., Ltd., Osaka (JP)

(72) Inventors: Manabu INOUE, Osaka (JP); Hiroyuki KADO, Osaka (JP); Shigeo KASAHARA, Hyogo (JP); Naoki KOSUGI, Kyoto (JP); Toshiyuki AOYAMA, Osaka (JP); Shuji INOUE, Osaka (JP); Kazushige TAKAGI, Osaka (JP); Akira TOKAI, Hyogo (JP); Takahito NAKAYAMA, Osaka (JP)

(21) Appl. No.: 14/527,582

(22) Filed: Oct. 29, 2014

(30) Foreign Application Priority Data
Oct. 30, 2013 (JP) 2013-224936
Sep. 9, 2014 (JP) 2014-182961

(51) Int. Cl. G06F 3/041

(52) U.S. Cl. CPC G06F 3/041
USPC 345/173

(57) ABSTRACT

An input device that can prevent a reduction in the accuracy of detection of a contact position, even when a display device operates in a PSR mode, is provided. The input device is provided in a display device configured to operate in either a first mode or a second mode, and to generate mode signal giving notice of the current operation mode and is configured to detect a contact position of a user. The input device includes a plurality of driving electrodes and touch controller. Touch controller is configured to determine the operation mode of display device based on mode signal, to generate touch driving signal based on a result of the determination, and to apply the generated touch driving signals to the driving electrodes.

### BACKGROUND OF THE INVENTION

1. Field of the Invention

The present disclosure relates to an input device that inputs coordinates onto a screen and a display device provided with the input device.

2. Background Art

There is an input device that has a screen input function for inputting information by allowing, for example, a finger of a user to make contact with a display screen (hereinbelow, referred to as a “touch operation” or merely referred to as “touch”). A display device that is provided with such an input device having a screen input function is used in mobile electronic devices such as a PDA (Personal Digital Assistance) and a mobile terminal, various home electric appliances, and stationary customer guide terminals such as an unattended reception machine and the like. As for such an input device using touch, there are known input devices of various systems such as a resistive film system which detects a change in resistance in a touched part, a capacitance coupling system which detects a change in capacitance, and an optical sensor system which detects a change in an amount of light in a part shielded by touch.

Recently, researches for reducing power consumption in a display device have been attempted. For example, there has been proposed a PSR (Panel Self Refresh) system which stores video data in a still image and displays the stored video data while displaying the still image. Unexamined Japanese Patent Publication No. 2013-037366 discloses a display device that is driven at a first frequency when displaying a moving image and driven at a second frequency that is lower than the first frequency when displaying a still image in order to further reduce power consumption in a PSR system.

### SUMMARY OF THE INVENTION

The present disclosure provides an input device that prevents a reduction in the accuracy of detection during a touch operation and a display device provided with the input device.

An input device in the present disclosure is provided in a display device and configured to detect a contact position of a user, the display device being configured to operate in any of a plurality of operation modes including a first mode in which the display device operates at a first frame frequency and a second mode in which the display device operates at a second frame frequency lower than the first frame frequency, and configured to generate a mode signal giving notice of the current operation mode. The input device includes a plurality of driving electrodes, a plurality of detection electrodes arranged to intersect the driving electrodes, and a touch controller. The touch controller is connected to the detection electrodes and configured to detect detection signals from the detection electrodes so as to detect the contact position of a user. Further, the touch controller is configured to determine the operation mode of the display device based on the mode signal, configured to generate touch driving signals based on a result of the determination, and configured to apply the generated touch driving signals to the driving electrodes.

A display device in the present disclosure is configured to operate in any of a plurality of operation modes including a first mode in which the display device operates at a first frame frequency and a second mode in which the display device operates at a second frame frequency lower than the first frame frequency, and configured to generate a mode signal giving notice of the current operation mode. The display device includes a plurality of scanning signal lines and an input device configured to detect a contact position of a user. The input device includes a plurality of driving electrodes, a plurality of detection electrodes arranged to intersect the driving electrodes, and a touch controller. The touch controller is connected to the detection electrodes and configured to detect detection signals from the detection electrodes so as to detect the contact position of a user. Further, the touch controller is configured to determine the operation mode of the display device, configured to generate touch driving signals based on a result of the determination based on the mode signal, and configured to apply the generated touch driving signals to the driving electrodes.

The input device and the display device provided with the input device in the present disclosure are effective in preventing a reduction in the accuracy of detection during a touch operation.

### BRIEF DESCRIPTION OF DRAWINGS

FIG. 1 is a block diagram illustrating an entire configuration of a display device having a touch sensor function in a first exemplary embodiment;

FIG. 2 is a perspective view illustrating an example of array of driving electrodes and detection electrodes included in a touch sensor in the first exemplary embodiment;

FIG. 3A is a diagram schematically illustrating a configuration of the touch sensor in the first exemplary embodiment;

FIG. 3B is a diagram illustrating an equivalent circuit of FIG. 3A;

FIG. 3C is a schematic view illustrating a state in which a touch operation is performed on the touch sensor of FIG. 3A;

FIG. 3D is a diagram illustrating an equivalent circuit of FIG. 3C;

FIG. 4 is a waveform diagram illustrating a change in a detection signal between when a touch operation is not performed on the touch sensor illustrated in FIG. 3A and when a touch operation is performed on the touch sensor illustrated in FIG. 3A;

FIG. 5 is a schematic view illustrating array structure of scanning signal lines of a liquid crystal panel and array structure of driving electrodes and detection electrodes of the touch sensor in the first exemplary embodiment;

FIG. 6 is a diagram schematically illustrating a relationship between input of scanning signals to the scanning signal lines and input of touch driving signals to the driving electrodes in the first exemplary embodiment;

FIG. 7 is a timing chart of scanning signals and touch driving signals in one frame period in a normal mode of driving method 1-1 in the first exemplary embodiment;

FIG. 8 is a timing chart illustrating an example of a relationship between a display update period and a touch detection period in one horizontal scanning period in the first exemplary embodiment;

FIG. 9 is a timing chart of scanning signals and touch driving signals in one frame period in a PSR mode of driving method 1-1 in the first exemplary embodiment;

FIG. 10 is a timing chart of scanning signals and touch driving signals in one frame period in a normal mode of driving method 2-1 in a second exemplary embodiment;

FIG. 11 is a timing chart of scanning signals and touch driving signals in one frame period in a PSR mode of driving method 2-1 in the second exemplary embodiment;

FIG. 12 is a timing chart of scanning signals and touch driving signals in one frame period in a normal mode of driving method 3-1 in a third exemplary embodiment;

FIG. 13 is a timing chart of scanning signals and touch driving signals in one frame period in a PSR mode of driving method 3-1 in the third exemplary embodiment; FIG. 14 is a timing chart of scanning signals and touch driving signals in one frame period in a normal mode of driving method 4-1 in a fourth exemplary embodiment;

FIG. 15 is a timing chart of scanning signals and touch driving signals in one frame period in a PSR mode of driving method 4-1 in the fourth exemplary embodiment;

FIG. 16 is a timing chart of scanning signals and touch driving signals in a PSR mode of driving method 1-2 in a fifth exemplary embodiment;

FIG. 17A is a timing chart illustrating, in a unit of line block, a relationship between supply of scanning signals to scanning signal lines and supply of touch driving signals to driving electrodes in a normal mode of driving method 1-2 in the fifth exemplary embodiment;

FIG. 17B is a timing chart illustrating, in a unit of line block, a relationship between supply of scanning signals to the scanning signal lines and supply of touch driving signals to the driving electrodes in the PSR mode of driving method 1-2 in the fifth exemplary embodiment;

FIG. 18 is a timing chart of scanning signals and touch driving signals in a PSR mode of driving method 2-2 in a sixth exemplary embodiment;

FIG. 19A is a timing chart illustrating, in a unit of line block, a relationship between supply of scanning signals to scanning signal lines and supply of touch driving signals to driving electrodes in a normal mode of driving method 2-2 in the sixth exemplary embodiment;

FIG. 19B is a timing chart illustrating, in a unit of line block, a relationship between supply of scanning signals to the scanning signal lines and supply of touch driving signals to the driving electrodes in the PSR mode of driving method 2-2 in the sixth exemplary embodiment;

FIG. 20 is a timing chart of scanning signals and touch driving signals in a PSR mode of driving method 3-2 in a seventh exemplary embodiment;

FIG. 21 is a timing chart of scanning signals and touch driving signals in a PSR mode of driving method 4-2 in an eighth exemplary embodiment;

FIG. 22 is a timing chart of scanning signals and touch driving signals in a PSR mode of driving method 1-3 in a ninth exemplary embodiment;

FIG. 23 is a timing chart of scanning signals and touch driving signals in a PSR mode of driving method 2-3 in a tenth exemplary embodiment;

FIG. 24 is a timing chart of scanning signals and touch driving signals in a PSR mode of driving method 3-3 in an eleventh exemplary embodiment;

FIG. 25 is a timing chart of scanning signals and touch driving signals in a PSR mode of driving method 4-3 in a twelfth exemplary embodiment;

FIG. 26 is a block diagram illustrating an entire configuration of a display device having a touch sensor function in a thirteenth exemplary embodiment; and

FIG. 27 is a timing chart in a PSR mode of driving method 1-1 in the thirteenth exemplary embodiment.

### DETAILED DESCRIPTION OF THE INVENTION

Hereinbelow, exemplary embodiments will be specifically described with reference to the drawings in an appropriate manner. However, unnecessarily detailed description may occasionally be omitted. For example, detailed description of already well-known matters and overlapping description of substantially the same configurations may occasionally be omitted. This is to avoid the following description from becoming unnecessarily redundant, and to make it easy for a person skilled in the art to understand the following description.

The accompanying drawings and the following description are provided so that a person skilled in the art can sufficiently understand the present disclosure. Therefore, the accompanying drawings and the following description are not intended to limit the subject matter defined in the claims.

In the following description of each of the exemplary embodiments, a PSR mode indicates a state in which a display device is driven by a PSR system (for example, a state in which the display device displays a still image) and a normal mode indicates a state in which the display device is not driven by the PSR system (for example, a state in which the display device displays a normal moving image). The display device operates at a first frame frequency (60 Hz, for example) in the normal mode and operates at a second frame frequency (approximately 20 Hz to 40 Hz, for example) that is lower than the first frame frequency in the PSR mode. In the claims, the normal mode corresponds to a first mode, the PSR mode corresponds to a second mode, and a PSR mode signal corresponds to a mode signal.

The display device holds one frame of last image data in the normal mode when shifting to the PSR mode and displays a still image using the held image data during the PSR mode. At this point, order and timing of outputting image data can be optionally changed. Therefore, a frame frequency in the PSR mode can be made lower than a frame frequency in the normal mode (a low-frame rate can be achieved).

The frame rate is a value that represents how many frames are displayed (how many times display update of an entire screen is performed) per unit time (one second, for example).

### First Exemplary Embodiment

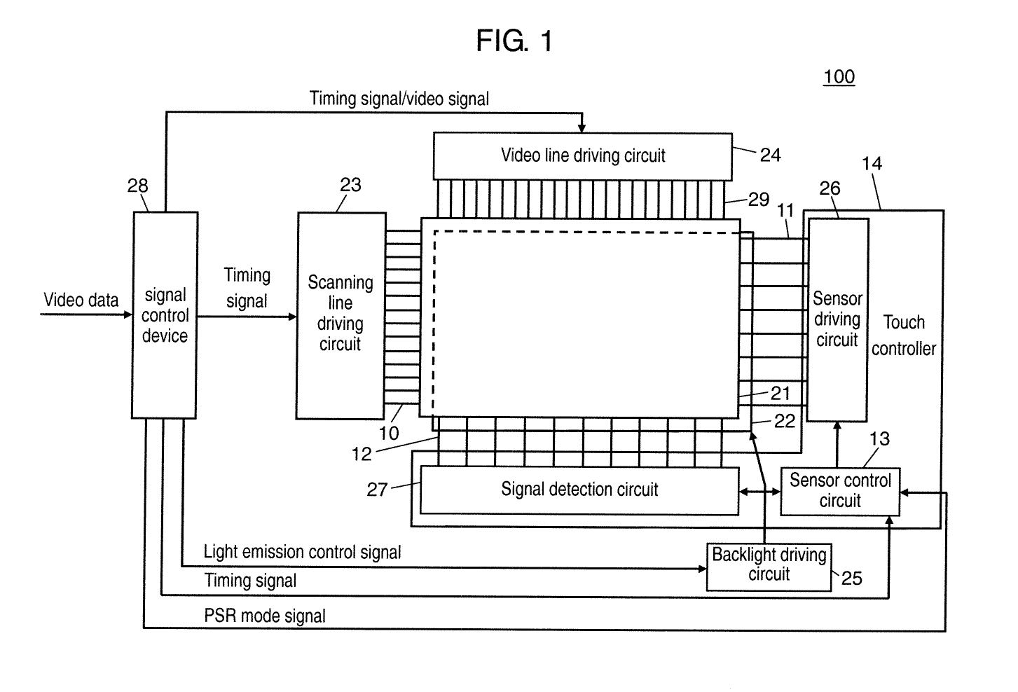

Hereinbelow, a first exemplary embodiment will be described with reference to FIG. 1 to FIG. 9.

[1-1. Configuration]

FIG. 1 is a block diagram illustrating an entire configuration of display device 100 having a touch sensor function in the first exemplary embodiment.

As illustrated in FIG. 1, display device 100 is provided with liquid crystal panel 21, backlight unit 22, scanning line driving circuit 23, video line driving circuit 24, backlight driving circuit 25, signal control device 28, and touch controller 14. Touch controller 14 is provided with sensor control circuit 13, sensor driving circuit 26, and signal detection circuit 27.

In the present exemplary embodiment and the subsequent exemplary embodiments, the input device includes driving electrodes 11, detection electrodes 12, and touch controller 14. Therefore, the input device described in the present exemplary embodiment is provided in display device 100 and integrated with display device 100. Hereinbelow, the input device is also referred to as a touch sensor or a touch panel. Further, a position with which, for example, a finger of a user makes contact in the input device is also referred to as a contact position or a touch position.

Liquid crystal panel 21 includes a TFT (thin film transistor) substrate which is composed of a transparent substrate such as a glass substrate, a counter substrate which is disposed to face the TFT substrate with a predetermined space from the TFT substrate, and a liquid crystal material which is enclosed between the TFT substrate and the counter substrate.

The TFT substrate is located on a back side (backlight side) of liquid crystal panel 21. In the TFT substrate, pixel electrodes which are arranged in matrix, thin film transistors (TFTs) as switching elements which are provided corresponding to the pixel electrodes and on/off control voltage application to the pixel electrodes, a common electrode, and the like are formed on the substrate which constitutes the TFT substrate.

The counter substrate is located on a front side (display surface side) of liquid crystal panel 21. In the counter substrate, a color filter (CF), a black matrix (BM), and the like are formed on the transparent substrate which constitutes the counter substrate. The CF includes at least three primary colors of red (R), green (G), and blue (B) and is located corresponding to the pixel electrodes. The BM is arranged between sub-pixels of the RGB and/or between pixels composed of the sub-pixels, is used for improving contrast, and is made of a light-shielding material. In the present exemplary embodiment, the TFTs each of which is formed in each sub-pixel on the TFT substrate are n-channel TFTs. A configuration will be described by defining a drain electrode and a source electrode. However, the described TFTs are merely an example, and the TFTs are not limited at all to n-channel type TFTs.

A plurality of video signal lines 29 and a plurality of scanning signal lines 10 are formed on the TFT substrate so as to be substantially perpendicular to each other. Each of scanning signal lines 10 extends in a horizontal direction of the TFTs and is connected to gate electrodes of plural ones of the TFTs in common. Each of video signal lines 29 extends in a vertical direction of the TFTs and is connected to drain electrodes of plural ones of the TFTs in common. Further, each of the TFTs has a source electrode to which a pixel electrode that is arranged in a pixel area corresponding to the TFT is connected.

In the present exemplary embodiment, a direction that is parallel to a long side of liquid crystal panel 21 is defined as the horizontal direction and a direction that is parallel to a short side of liquid crystal panel 21 is defined as the vertical direction.

On/off operations of the respective TFTs formed on the TFT substrate are controlled in a unit of horizontal row in response to scanning signals applied to scanning signal lines 10. In each TFT in a horizontal row that is turned to an on state, a pixel electrode is set to a potential (pixel voltage) corresponding to a video signal applied to corresponding video signal line 29. Liquid crystal panel 21 includes the plurality of pixel electrodes and the common electrode which is provided to face the pixel electrodes. Liquid crystal panel 21 controls orientation of liquid crystal in each pixel area by electric fields generated between the pixel electrodes and the common electrode to change transmittance with respect to light entered from backlight unit 22 to thereby form an image on a display surface.

Backlight unit 22 is disposed on the back side of liquid crystal panel 21 and applies light from a back face of liquid crystal panel 21. As for backlight unit 22, there are known, for example, a backlight unit having a structure in which a plurality of light emitting diodes are arrayed to configure a surface light source and a backlight unit having a structure in which a surface light source is configured by using light from a light emitting diode in combination with a light-guiding plate and a diffuse reflection plate.

Scanning line driving circuit 23 is connected to scanning signal lines 10 formed on the TFT substrate. Scanning line driving circuit 23 selects scanning signal lines 10 in order in response to timing signals 1, 2 input from signal control device 28, and applies voltage for turning on TFTs to selected scanning signal line 10. For example, scanning line driving circuit 23 includes a shift register. The shift register starts an operation upon receiving trigger signals (timing signals 1, 2) from signal control device 28. Then, scanning line driving circuit 23 sequentially selects scanning signal lines 10 in order along a vertical scanning direction, and applies a scanning pulse to selected scanning signal line 10.

Video line driving circuit 24 is connected to video signal lines 29 formed on the TFT substrate. In accordance with the selection of scanning signal lines 10 performed by scanning line driving circuit 23, video line driving circuit 24 applies voltage that corresponds to a video signal indicating a gradation value of each sub-pixel to each TFT that is connected to selected scanning signal line 10. As a result, the video signal is written in sub-pixels that correspond to selected scanning signal line 10.

Backlight driving circuit 25 allows backlight unit 22 to emit light at timing and luminance both corresponding to a light emission control signal input from signal control device 28.

In liquid crystal panel 21, driving electrodes 11 and detection electrodes 12, both are as electrodes constituting the touch sensor, are arranged to intersect each other.

The touch sensor that includes driving electrodes 11 and detection electrodes 12 performs, between driving electrodes 11 and detection electrodes 12, response detection (detection of a change in voltage) based on input of an electric signal and a change in capacitance to thereby detect contact of an object (a finger of a user, for example) with the display surface. Sensor driving circuit 26 and signal detection circuit 27 are provided as electric circuits that detect the contact.

Sensor driving circuit 26 is an alternating current (AC) signal source, and is connected to driving electrodes 11. For example, when a sensor signal as a timing signal is input to sensor driving circuit 26 from sensor control circuit 13, sensor driving circuit 26 sequentially selects driving electrodes 11 in order along the vertical scanning direction, and applies touch driving signal Txv of rectangular pulse voltage to selected driving electrode 11.

Driving electrodes 11 and scanning signal lines 10 are formed to extend in the horizontal direction (row direction) and arrayed side by side in the vertical direction (column direction) on the TFT substrate. Sensor driving circuit 26 electrically connected to driving electrodes 11 and scanning line driving circuit 23 electrically connected to scanning signal lines 10 are disposed along vertical sides of a display area in which pixels are arrayed. Scanning line driving circuit 23 is disposed on one of right and left vertical sides and sensor driving circuit 26 is disposed on the other side.

Signal detection circuit 27 is provided with a plurality of detection circuits which detect a change in capacitance and is connected to detection electrodes 12. Signal detection circuit 27 includes the detection circuits provided for the respective detection electrodes 12 and is configured to detect detection signals Rxv from detection electrodes 12.

The contact position of an object on the display surface is obtained in sensor control circuit 13 based on in which detection electrode 12 a signal at the time of the contact is detected and to which driving electrode 11 touch driving signal Txv is applied at the time of the contact. In sensor control circuit 13, an intersection point between decided driving electrode 11 and decided detection electrode 12 is obtained as the contact position.

Signal control device 28 is provided with an arithmetic processing circuit such as a CPU and a memory such as a ROM and/or a RAM. Signal control device 28 performs various kinds of video signal processing such as color adjustment based on video data input to signal control device 28 to thereby generate a video signal that indicates gradation of each sub-pixel and supplies the generated video signal to video line driving circuit 24. Signal control device 28 generates timing signals to scanning line driving circuit 23, video line driving circuit 24, backlight driving circuit 25, sensor control circuit 13 based on the video data input to signal control device 28 and supplies the generated timing signals to these circuits. Signal control device 28 supplies, as the light emission control signal to backlight driving circuit 25, a luminance signal for controlling luminance of a backlight (a light emitting diode, for example) to backlight driving circuit 25 based on the input video data. Signal control device 28 generates the timing signals to drive liquid crystal panel 21 in either the normal mode of the operation mode or the PSR mode of the operation mode, based on the input video data. And, signal control device 28 supplies the timing signals to the respective circuits.

In addition, signal control device 28 generates a PSR mode signal indicating whether liquid crystal panel 21 is being driven in the normal mode of the operation mode or in the PSR mode of the operation mode, and outputs the PSR mode signal. The PSR mode signal is input to sensor control circuit 13 of touch controller 14. This structure allows signal control device 28 to give touch controller 14 notice of whether display device 100 is operating in the normal mode of the operation mode or in the PSR mode of the operation mode.

According to the present exemplary embodiment, the PSR mode signal is constituted of a binary signal which becomes low level (Lo) in the normal mode, and high level (Hi) in the PSR mode. The low level and the high level set for the respective modes may be switched between each other. The PSR mode signal may be any signals as long as distinction can be made between the normal mode and the PSR mode. Accordingly, the PSR mode signal is not required to be binary signal having low level and high level.

Sensor control circuit 13 of touch controller 14 recognizes whether display device 100 is operating in the normal mode of the operation mode or in the PSR mode of the operation mode based on the PSR mode signal. Sensor control circuit 13 controls sensor driving circuit 26 and signal detection circuit 27 in response to the timing signals and the PSR mode signal input from signal control device 28.

Scanning line driving circuit 23, video line driving circuit 24, sensor driving circuit 26, sensor control circuit 13, and signal detection circuit 27 which are connected to the signal lines and the electrodes of liquid crystal panel 21 are each configured in such a manner that a semiconductor chip of each of the circuits is mounted on a flexible wiring board, a printed wiring board, or a glass substrate. However, scanning line driving circuit 23, video line driving circuit 24, sensor driving circuit 26, and sensor control circuit 13 may be mounted on the TFT substrate by being simultaneously formed with the TFTs and the like.

Touch controller 14 is provided with sensor driving circuit 26, signal detection circuit 27, and sensor control circuit 13. Touch controller 14 controls the touch sensor based on timing signals and the PSR mode signal input from signal control device 28. Sensor driving circuit 26, signal detection circuit 27, and sensor control circuit 13 may be separate semiconductors or may also be integrated as a single semiconductor as a whole.

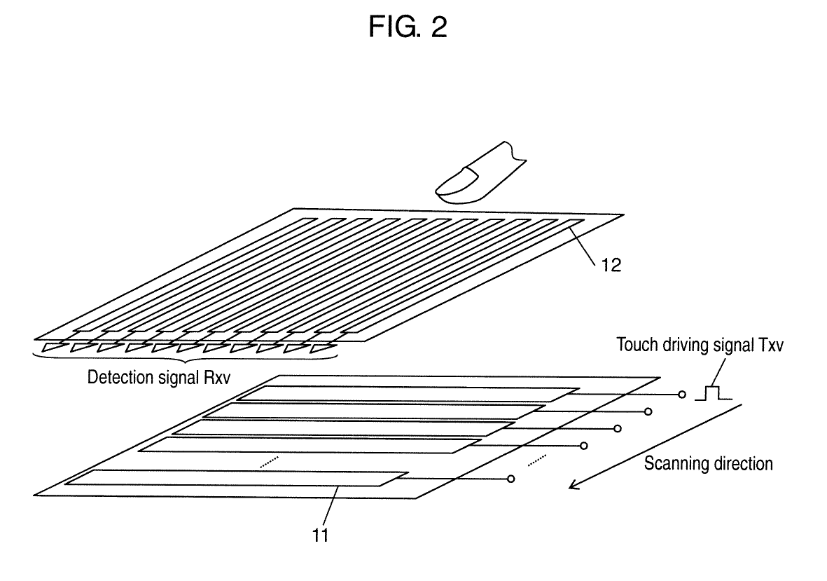

FIG. 2 is a perspective view illustrating an example of array of the driving electrodes and the detection electrodes included in the touch sensor in the first exemplary embodiment. As illustrated in FIG. 2, the touch sensor as the input device includes driving electrodes 11 and detection electrodes 12. Driving electrodes 11 are a plurality of striped electrode patterns extending in a right-left direction of FIG. 2. Detection electrodes 12 are a plurality of striped electrode patterns extending in a direction that intersects the extending direction of the electrode patterns of driving electrodes 11. Driving electrodes 11 and detection electrodes 12 intersect each other to form intersection parts, and a capacitative element having capacitance is formed in each of the intersection parts.

Driving electrodes 11 are arrayed to extend in a direction parallel to an extending direction of scanning signal lines 10. As will be described in detail below, when M scanning signal lines 10 (M is a natural number) that are adjacent to each other are defined as one line block, each of driving electrodes 11 is disposed corresponding to each of N line blocks (N is a natural number), and a touch driving signal is applied to each of the line blocks.

During a touch detection operation, touch driving signal Txv is applied from sensor driving circuit 26 to each of driving electrodes 11 so as to perform line sequential scanning in a time division manner for each of the line blocks. As a result, one line block to be a detection target is sequentially selected. Further, when signal detection circuit 27 receives detection signal Rxv from detection electrode 12, touch detection in one line block is performed.

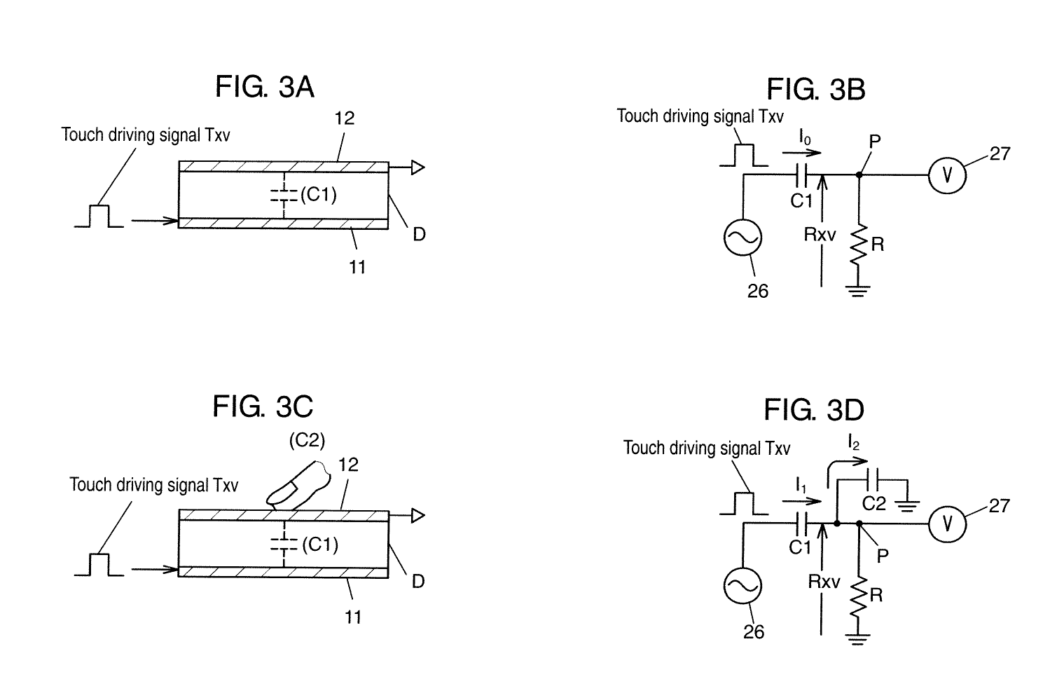

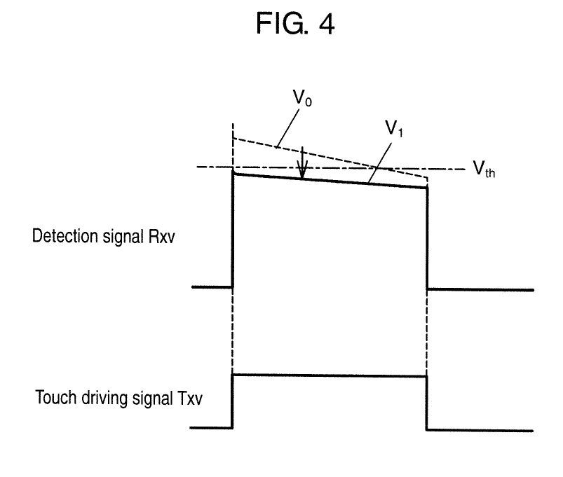

Next, a principle of touch detection (voltage detection system) in a capacitance type touch sensor will be described with reference to FIG. 3 and FIG. 4.

FIG. 3A is a diagram schematically illustrating a configuration of the touch sensor in the first exemplary embodiment. FIG. 3B is a diagram illustrating an equivalent circuit of FIG. 3A. FIG. 3C is a schematic view illustrating a state in which a touch operation is performed on the touch sensor of FIG. 3A. FIG. 3D is a diagram illustrating an equivalent circuit of FIG. 3C.

FIG. 4 is a waveform diagram illustrating a change in a detection signal between when a touch operation is not performed on the touch sensor illustrated in FIG. 3A and when a touch operation is performed on the touch sensor illustrated in FIG. 3A.

In the capacitance type touch sensor, driving electrodes 11 and detection electrodes 12 which are arranged in matrix to intersect each other as illustrated in FIG. 2 face each other with dielectric D interposed between driving electrodes 11 and detection electrodes 12 as illustrated in FIG. 3A. As a result, the capacitative element is formed in each of the intersection parts between driving electrodes 11 and detection electrodes 12. The equivalent circuit is represented as illustrated in FIG. 3B. Capacitative element C1 includes driving electrode 11, detection electrode 12, and dielectric D. Capacitative element C1 has one end that is connected to sensor driving circuit 26 as the AC signal source and the other end P that is grounded via resistor R and connected to signal detection circuit 27 as a voltage detector.

When touch driving signal Txv (FIG. 4) having a pulse voltage waveform and a frequency of approximately several tens kHz to several hundreds kHz (a predetermined frequency) is applied to driving electrode 11 (one end of capacitative element C1) from sensor driving circuit 26 as the AC signal source, an output waveform (detection signal Rxv) as illustrated in FIG. 4 appears in detection electrode 12 (the other end P of capacitative element C1).

When a finger is not in contact with (or not in close to) the display screen, current I0 that corresponds to a capacitance value of capacitative element C1 flows accompanied with charge/discharge to capacitative element C1 as illustrated in FIG. 3B. A voltage waveform at the other end P of capacitative element C1 is formed in waveform V0 of FIG. 4 and detected by signal detection circuit 27 as the voltage detector.

On the other hand, when a finger is in contact with (or in close to) the display screen, capacitative element C2 formed by the finger is added in series to capacitative element C1 in the equivalent circuit as illustrated in FIG. 3D. In this state, current I1 and current I2 flow respectively accompanied with charge/discharge to capacitative element C1 and capacitative element C2. The voltage waveform at the other end P of capacitative element C1 at this point is formed in waveform V1 of FIG. 4 and detected by signal detection circuit 27 as the voltage detector. A voltage potential at point P at this point is a divided voltage potential that is determined by values of current I1 and current I2 respectively flowing in capacitative element C1 and capacitative element C2. Therefore, waveform V1 has a lower voltage value than waveform V0 in the non-contact state.

Signal detection circuit 27 compares a voltage potential of detection signal Rxv output from each of detection electrodes 12 with predetermined threshold voltage Vth. When detection signal Rxv is threshold voltage Vth or more, signal detection circuit 27 determines the non-contact state. On the other hand, when detection signal Rxv is less than threshold voltage Vth, signal detection circuit 27 determines the contact state. In this manner, the touch detection can be performed. In the present exemplary embodiment, the touch detection is not limited at all to voltage detection. As for a method for detecting a change in capacitance other than voltage detection, for example, there is a method that detects current.

[1-2. Operation]

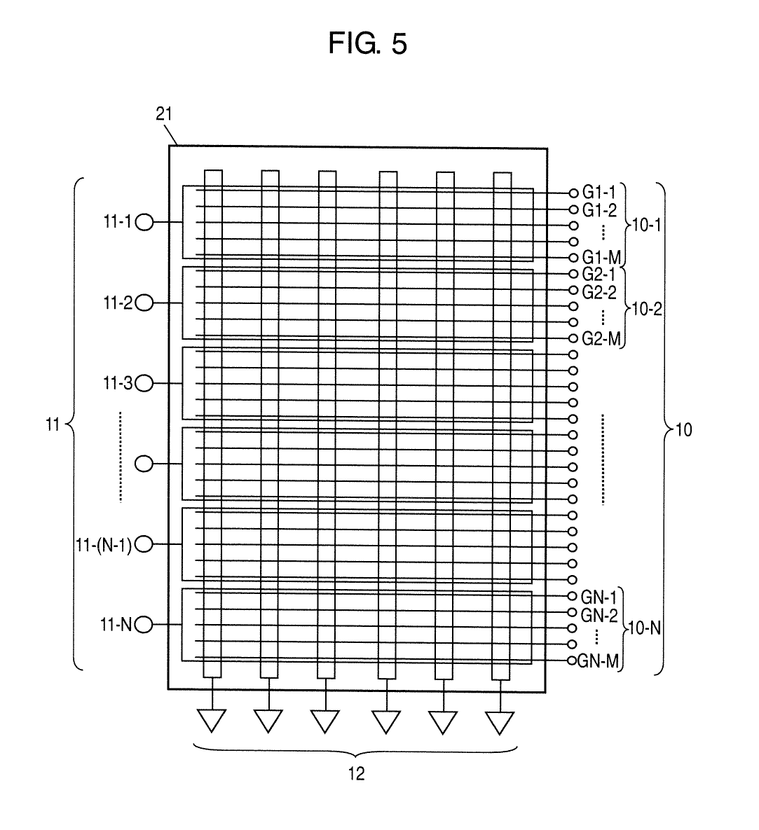

Next, an example of a method for driving the touch sensor in the present exemplary embodiment will be described with reference to FIG. 5 to FIG. 9.

FIG. 5 is a schematic view illustrating array structure of scanning signal lines 10 of liquid crystal panel 21 and array structure of driving electrodes 11 and detection electrodes 12 of the touch sensor IN the first exemplary embodiment. As illustrated in FIG. 5, X scanning signal lines 10 which extend in the horizontal direction are arrayed by being divided into N line blocks 10-1, 10-2, . . . , 10-N (N is a natural number), wherein each of the N line blocks includes M scanning signal lines 10 (M is a natural number) that are adjacent to each other (for example, scanning signal lines G1-1, G1-2, . . . , G1-M).

In FIG. 5 and the subsequent figures, each of scanning signal lines 10 is also referred to as “scanning signal line Ga-b”, where “a” indicates that the scanning signal line 10 is included in an a-th line block from the top and “b” indicates that the scanning signal line 10 is disposed in a b-th position in the line block. That is, “scanning signal line Ga-b” indicates scanning signal line 10 that is located in the b-th position in line block 10-a. Further, N×M is equal to total number X of scanning signal lines 10.

Driving electrodes 11 of the touch sensor are arrayed in such a manner that N driving electrodes 11-1, 11-2, . . . , 11-N extend in the horizontal direction so as to correspond to line blocks 10-1, 10-2, . . . , 10-N. A plurality of detection electrodes 12 are arrayed to extend in the vertical direction so as to intersect N driving electrodes 11-1, 11-2, . . . , 11-N.

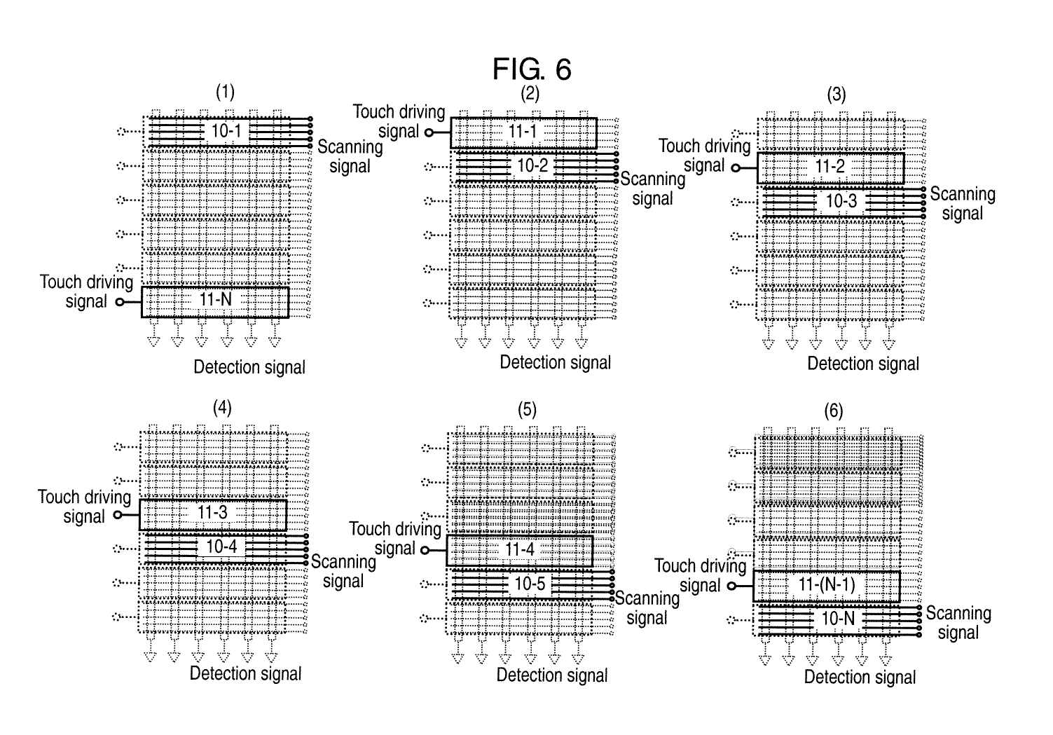

FIG. 6 is a diagram schematically illustrating a relationship between input of scanning signals to scanning signal lines 10 and input of touch driving signals to driving electrodes 11 in the first exemplary embodiment. The scanning signals are sequentially applied to the respective scanning signal lines 10 in order to perform update of a display image (hereinbelow, referred to as “display update”) in liquid crystal panel 21. The touch driving signals are sequentially applied to the respective driving electrodes 11 in order to perform the touch detection in the touch sensor. In the present exemplary embodiment and the subsequent exemplary embodiments, time required to apply scanning signals to all scanning signal lines 10 that constitute one line block is referred to as “a one-line block scanning period”. In FIG. 6, time passes from (1) to (6). Each of (1) to (6) of FIG. 6 illustrates a state in the one-line block scanning period.

In the exemplary embodiment, as illustrated in (1) of FIG. 6, in a line block scanning period during which scanning signals are sequentially applied to scanning signal lines G1-1 to G1-M that constitute line block 10-1 located on the top, a touch driving signal is applied to driving electrode 11-N that corresponds to line block 10-N located on the bottom. In the subsequent line block scanning period, as illustrated in (2) of FIG. 6, scanning signals are sequentially applied to scanning signal lines G2-1 to G2-M that constitute the second line block 10-2 from the top. In this line block scanning period, a touch driving signal is applied to driving electrode 11-1 that corresponds to line block 10-1 to which the scanning signals have been applied in the preceding line block scanning period.

As illustrated in (3) to (6) of FIG. 6, scanning signals are sequentially applied to scanning signal lines G3-1 to GN-M that constitute line blocks 10-3, 10-4, 10-5, . . . , 10-N, so that line block scanning periods sequentially progress. On the other hand, in each of the line block scanning periods, touch driving signals are sequentially applied to driving electrodes 11-2, 11-3, 11-4, . . . , 11-(N−1) that correspond to line blocks 10-2, 10-3, 10-4, . . . , 10-(N−1) to which scanning signals have been applied in the preceding line block scanning periods. In the present exemplary embodiment, order of applying scanning signals to scanning signal lines 10 and order of applying touch driving signals to driving electrodes 11 are configured in this manner.

Specifically, in the present exemplary embodiment, when a touch driving signal is applied to each of driving electrodes 11, driving electrode 11 that corresponds to a line block that differs from a line block to which scanning signal lines 10 to which scanning signals are applied belong is selected, and a touch driving signal is applied to selected driving electrode 11 in each of the line block scanning periods.

In FIG. 6, there has been described the example in which a touch driving signal is applied to driving electrode 11 that corresponds to a line block to which scanning signals have been applied in the preceding line block scanning period. However, the present exemplary embodiment is not limited at all to this configuration. In the present exemplary embodiment, it is only required to prevent a touch driving signal from being applied to driving electrode 11 that corresponds to a line block to which scanning signals are applied. For example, one or two or more line blocks may be interposed between a line block to which scanning signals are applied and driving electrode 11 to which a touch driving signal is applied.

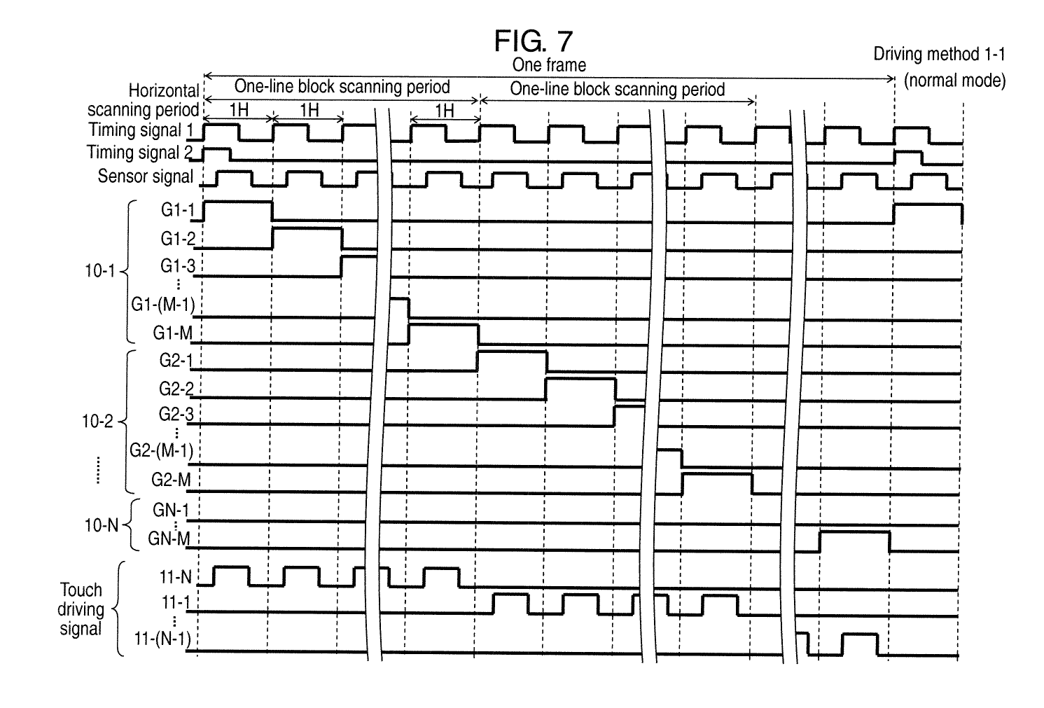

FIG. 7 is a timing chart of scanning signals and touch driving signals in one frame period in a normal mode of driving method 1-1 in the first exemplary embodiment. FIG. 7 illustrates the timing chart based on the example illustrated in FIG. 6.

In the normal mode, signal control device 28 outputs the low-level PSR mode signal. When the PSR mode signal input from signal control device 28 is low-level signal, touch controller 14 determines that display device 100 is operating in the normal mode, and generates touch driving signals corresponding to this determination.

As illustrated in FIG. 7, in the normal mode of driving method 1-1, scanning signals are sequentially applied to scanning signal lines 10 in such order as line block 10-1, 10-2, . . . , 10-N (in such order as scanning signal line G1-1, G1-2, GN-M in the example illustrated in FIG. 7) in each horizontal scanning period (1H) in one frame period to perform the display update. Within the period during which the scanning signals are applied, touch driving signals for the touch detection are sequentially applied to driving electrodes 11-N, 11-1, 11-2, . . . , 11-(N−1) that respectively correspond to line blocks 10-N, 10-1, 10-2, . . . , 10-(N−1) in a unit of line block scanning period.

First and second timing signals are generated by signal control device 28 for an operation of liquid crystal panel 21. In FIG. 7, timing signal 1 as the first timing signal represents timing of generating each scanning signal, and timing signal 2 as the second timing signal represents generation start timing of the first scanning signal in one frame period. Timing signal 1 is generated substantially at every horizontal scanning period (every H). Timing signal 2 is generated once in one frame period. In the example of FIG. 7, there is illustrated a case in which scanning is started from line block 10-1. Specifically, when timing signal 1 is input to scanning line driving circuit 23 after timing signal 2 is input to scanning line driving circuit 23, a scanning signal is applied to scanning signal line G1-1.

Sensor signal is generated for an operation of sensor driving circuit 26. Sensor control circuit 13 generates the sensor signal based on timing signals 1, 2 input from signal control device 28 so as to have predetermined delay from timing signal 1. Sensor driving circuit 26 applies touch driving signals to driving electrodes 11 based on the sensor signal generated by sensor control circuit 13. As illustrated in FIG. 7, the sensor signal is synchronized with the scanning signals in the normal mode.

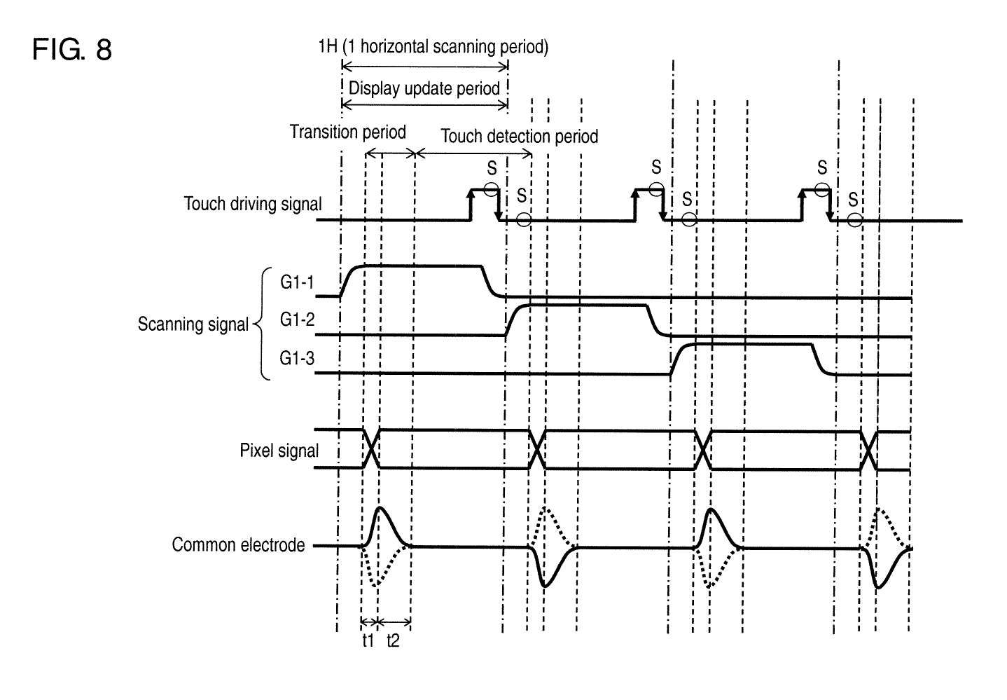

FIG. 8 is a timing chart illustrating an example of a relationship between a display update period and a touch detection period in one horizontal scanning period in the first exemplary embodiment. In driving method 1-1, no predetermined blank period exists between the scanning signals.

As illustrated in FIG. 8, in each display update period, a scanning signal is sequentially applied to each of scanning signal lines 10, and a pixel signal corresponding to an input video signal is input to each of video signal lines 29 which are connected to switching elements of the respective pixel electrodes of the respective pixels.

In the present exemplary embodiment, the touch detection period is provided at timing based on the display update period. The touch detection period is defined as a period obtained by subtracting a transition period from the display update period. That is, a pulse voltage as the touch driving signal is applied to each of driving electrodes 11 when a scanning signal rises to a predetermined potential and voltage displacement in each of the electrodes is converged. The touch detection period is started from a displacement point of the potential caused by the rising of the pulse voltage. Further, touch detection timing S exists at two positions, specifically, a position immediately before a falling point of the pulse voltage and a position at a touch detection period finishing point. The transition period includes period t1 during which a pixel signal is displaced and period t1+t2 during which a potential of the common electrode is displaced and converged accompanied with displacement of the pixel signal. This is because of that variations in the potential of the common electrode occur in transition period t1 of the pixel signal because of parasitic capacitance coupling inside the panel. Period t1 and period t2 are set for preventing the variations from occurring during the touch detection period.

An example of the touch detection timing is illustrated in FIG. 8. However, the touch detection timing is not limited to the timing illustrated in FIG. 8, and is desirably set so as to avoid a period during which noise is generated in display device 100 because of a display update operation.

The touch detection operation during the touch detection period is as described above with reference to FIG. 3 and FIG. 4.

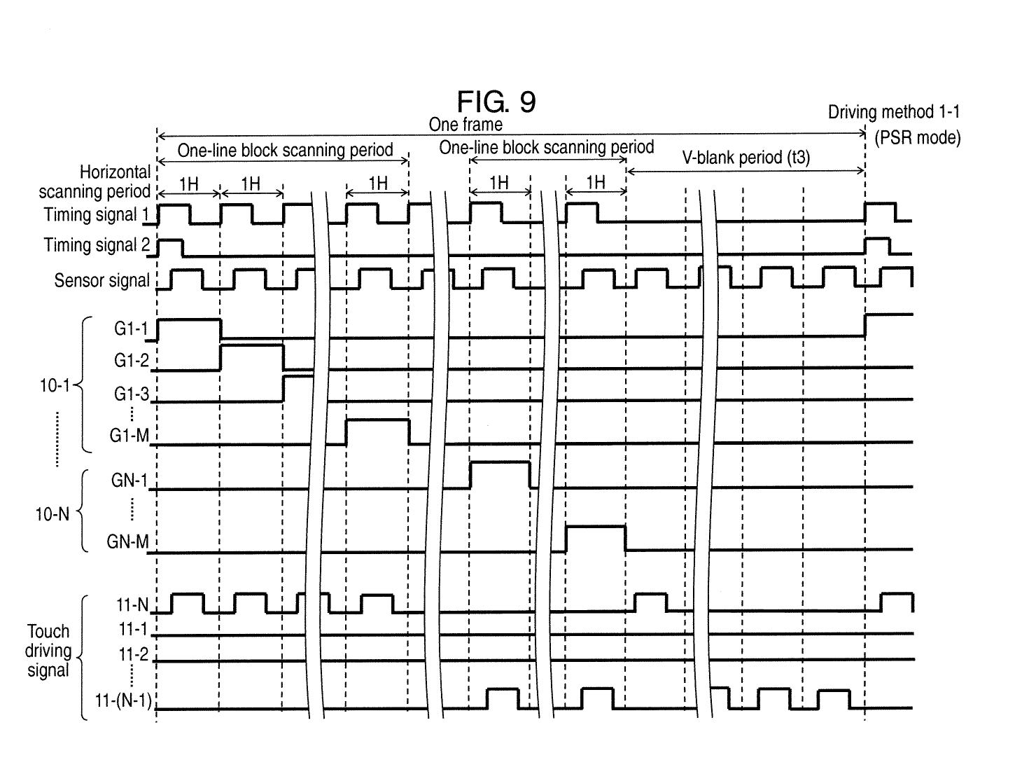

Next, a touch detection operation in a PSR mode in driving method 1-1 will be described with reference to FIG. 9. FIG. 9 is a timing chart of scanning signals and touch driving signals in one frame period in the PSR mode of driving method 1-1 in the first exemplary embodiment.

In the PSR mode, signal control device 28 outputs the high-level PSR mode signal. When the PSR mode signal input from signal control device 28 is high-level signal, touch controller 14 determines that display device 100 is operating in the PSR mode, and generates touch driving signals corresponding to this determination.

As illustrated in FIG. 9, when display device 100 shifts to the PSR mode and achieves a low frame rate, no timing signal 1 is input to sensor control circuit 13 until one frame is finished after scanning line driving circuit 23 outputs the last scanning signal (a scanning signal applied to scanning signal line GN-M in an example illustrated in FIG. 9). In other words, as illustrated in FIG. 9, no scanning signal is output from scanning line driving circuit 23 in period t3 (hereinbelow, referred to as a “V-blank period”) from completion of output of a scanning signal that corresponds to last timing signal 1 (the scanning signal applied to scanning signal line GN-M in the example illustrated in FIG. 9) until start of input of the first scanning signal in a next frame (a scanning signal applied to scanning signal line G1-1 in the example illustrated in FIG. 9). That is, the V-brank period indicates a period in which no scanning signal is applied to scanning signal lines 10 (a period during which generation of scanning signals is stopped), the period being provided after finish of application of scanning signals to scanning signal lines 10 for one screen. Therefore, when sensor control circuit 13 follows the same operation as the operation in the normal mode during a PSR mode period, also no sensor signal is output in the V-blank period. That is, achieving a low frame rate leads to a reduction in a report rate of the touch panel.

When a frame rate in the normal mode is, for example, 60 Hz and a frame rate in the PSR mode is, for example, 40 Hz, a length of one frame period in the PSR mode is approximately 1.5 times a length of one frame period in the normal mode. A length of the V-blank period in the PSR mode is determined based on the difference between the frame period in the normal mode and the frame period in the PSR mode. However, in the present exemplary embodiment, the frame rate in each of the modes is not limited at all to these values.

The report rate of the touch panel is a value that indicates how many times a series of operations is repeatedly performed in unit time (one second, for example), wherein the series of operations includes scanning for one screen for touch detection, calculation of a touch position for identifying the touch position, and output of the calculated touch position (coordinates). When a value of the report rate is larger, a number of times of outputting coordinates of the touch position in unit time increases. As a result, temporal resolution for the coordinates of the touch position (capacity indicating how many times output of the coordinates of the touch position can be performed in unit time) is improved. Further, spatial resolution for the coordinates of the touch position (capacity indicating how accurately the coordinates of the touch position can be detected) depends on a number of driving electrodes 11 and a number of detection electrodes 12.

A reduction in the report rate in the PSR mode is not desirable because the reduction makes it difficult to follow a quick touch operation. Therefore, in the first exemplary embodiment, sensor control circuit 13 determines whether the current operation mode is the normal mode or the PSR mode based on the PSR mode signal. Specifically, when the PSR mode signal switches from low level to high level, sensor control circuit 13 determines that display device 100 has shifted from the normal mode to the PSR mode. When determining that display device 100 has shifted to the PSR mode, as illustrated in FIG. 9, sensor control circuit 13 changes a method for generating sensor signal from the normal mode to thereby prevent a reduction in the report rate.

Although the timing chart in which the V-blank period is not generated in the normal mode is illustrated in FIG. 7, the V-blank period may be generated in the normal mode. Both in the normal mode and the PSR mode, the V-blank period indicates a period from finish of the horizontal scanning period corresponding to last timing signal 1 in one frame period until generation of timing signal 2 in the next frame. Therefore, in FIG. 7, it can be regarded that a V-blank period having a length of substantially zero is generated. Because the frame rate in the PSR mode is lower than the frame rate in the normal mode, the V-blank period in the PSR mode is longer than the V-blank period in the normal period.

When determining that display device 100 has shifted from the normal mode to the PSR mode, based on the PSR mode signal, sensor control circuit 13 generates a sensor signal at the same timing as the timing in the normal mode even in the V-blank period during which no timing signal 1 is generated, and outputs the generated sensor signal to sensor driving circuit 26. Upon receiving the sensor signal, sensor driving circuit 26 applies a touch driving signal to driving electrode 11. Signal detection circuit 27 detects detection signal Rxv.

By performing such control, sensor control circuit 13 can generate the sensor signal at predetermined timing even when no timing signal 1 is input from signal control device 28. Therefore, even when display device 100 shifts to the PSR mode and achieves a low frame rate, the report rate of the touch panel can be maintained substantially equal to the report rate in the normal mode.

Because no scanning signal is generated in the V-blank period in the PSR mode, sensor driving circuit 26 does not have to take into consideration timing restriction illustrated in FIG. 8 when generating touch driving signals. Therefore, the sensor signal may be generated not at the same timing as the timing in the normal mode, but at timing that differs from the timing in the normal mode in the V-blank period.

[1-3. Effect]

As described above, the input device of the present exemplary embodiment is provided in display device 100, and configured to detect the contact position of a user. Display device 100 is configured to operate in any of a plurality of operation modes including a first mode in which the display device operates at the first frame frequency and a second mode in which the display device operates at the second frame frequency lower than the first frame frequency, and configured to generate the PSR mode signal giving notice of the current operation mode. The input device is provided with driving electrodes 11, detection electrodes 12 arranged to intersect driving electrodes 11, and touch controller 14. Touch controller 14 is connected to detection electrodes 12, and configured to detect a detection signal from detection electrodes 12 to detect the contact position of a user. Further, touch controller 14 is configured to determine the operation mode of display device 100 based on the PSR mode signal, configured to generate touch driving signals based on a result of the determination, and configured to apply the generated touch driving signals to driving electrodes 11.

Display device 100 is configured to operate with the V-blank period provided in one frame period, and no scanning signal is applied to scanning signal lines 10 in the V-blank period. Touch controller 14 is configured to determine the operation mode of display device 100, based on the PSR mode signal. For example, when the PSR mode signal switches from low level to high level, touch controller 14 determines that display device 100 has shifted from the normal mode to the PSR mode.

Display device 100 is configured so that scanning signals are generated based on the first timing signal generated depending on the operation mode and a second timing signal generated once per one frame and no first timing signal is generated in the V-blank period when display device 100 operates in the second mode (PSR mode). Moreover, signal control device 28 of display device 100 is configured to generate the PSR mode signal which gives touch controller 14 notice of the operation mode of display device 100. When determining that display device 100 operates in the first mode (normal mode), based on the PSR mode signal, touch controller 14 generates touch driving signals based on the first timing signal. On the other hand, when determining that display device 100 operates in the second mode (PSR mode), based on the PSR mode signal, touch controller 14 generates touch driving signals based on the first timing signal and generates touch driving signals also in the V-brank period during which no first timing signal is generated.

As a result, even when display device 100 has shifted from the normal mode to the PSR mode and operates at a lower frame rate than the normal mode, it is possible to maintain the report rate of the touch panel substantially equal to the report rate in the normal mode and to prevent a reduction in the accuracy of detection during the touch operation.

### Second Exemplary Embodiment

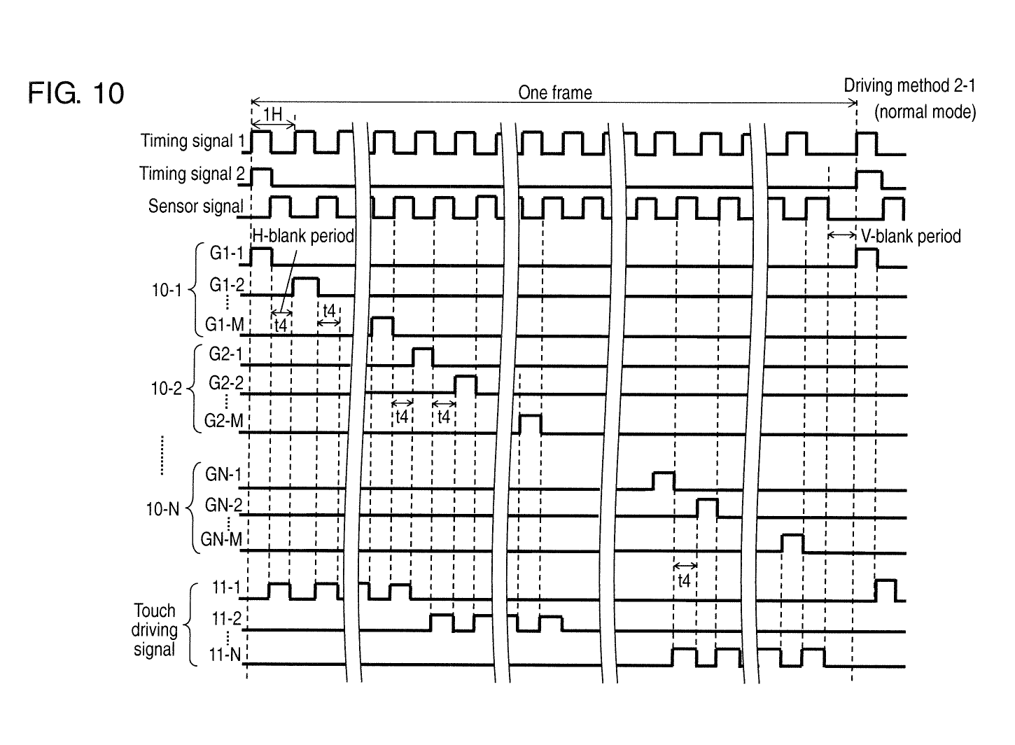

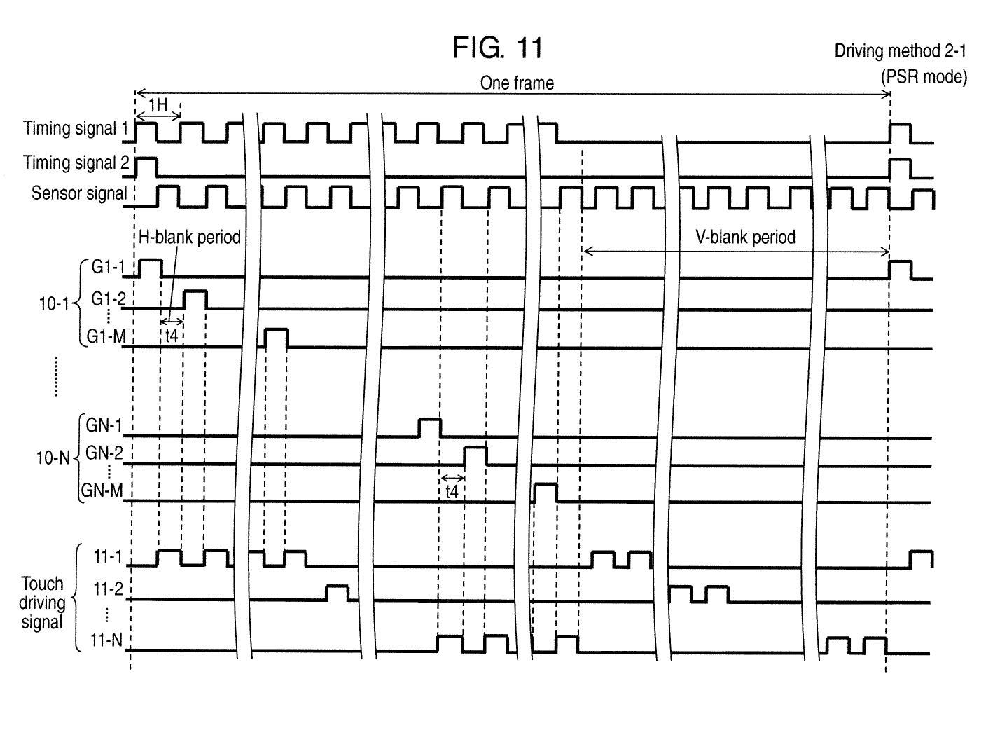

Hereinbelow, an operation when a display device is driven by driving method 2-1 that differs from driving method 1-1 described in the first exemplary embodiment will be described with reference to FIG. 10 and FIG. 11.

[2-1. Configuration]

The display device in a second exemplary embodiment has substantially the same configuration as the configuration of display device 100 described in the first exemplary embodiment. Therefore, description of the configuration of the display device in the second exemplary embodiment will be omitted. Further, the operation mode of the display device is determined by the touch controller based on the PSR mode signal in the same manner as in the first exemplary embodiment. Therefore, description of this determination method will be omitted.

[2-2. Operation]

FIG. 10 is a timing chart of scanning signals and touch driving signals in one frame period in a normal mode of driving method 2-1 in the second exemplary embodiment.

As illustrated in FIG. 10, in driving method 2-1, scanning signals are generated so that predetermined periods t4 (hereinbelow, referred to as “H-blank periods”) each of which exists between two scanning signals, for example, between a scanning signal applied to scanning signal line G1-1 and a scanning signal applied to scanning signal line G1-2. That is, the H-blank period indicates a period which is provided in one horizontal scanning period, and in which no scanning signal is applied to scanning signal lines 10 (a period during which generation of scanning signals is stopped). In driving method 2-1, by preventing occurrence of a change in a video signal (pixel signal) in the H-blank periods, it is not necessary to take into consideration voltage fluctuation caused by parasitic capacitance within a liquid crystal panel (hereinbelow, such voltage fluctuation is also referred to as “display noise”) in the H-blank periods. Therefore, as illustrated in FIG. 10, by applying a touch driving signal to driving electrode 11 during each of the H-blank periods to perform transmission/reception of a touch signal, sensitivity of the touch sensor can be improved compared to driving method 1-1 illustrated in FIG. 7 and FIG. 9 because of the following reason. In driving method 1-1, in order to reduce display noise, timing of applying touch driving signals is devised. However, it is difficult to completely eliminate display noise caused by video signal lines 29 and the like because of time constraint.

In driving method 2-1, touch detection is performed during the H-blank periods. Therefore, as illustrated in FIG. 10, it is possible to apply a touch driving signal to driving electrode 11 that corresponds to a line block to which scanning signals are applied. For example, it is possible to apply a touch driving signal to driving electrode 11-1 that corresponds to line block 10-1 in a line block scanning period during which scanning signals are applied to scanning signal lines G1-1 to G1-M that constitute line block 10-1.

A V-blank period in driving method 2-1 indicates a period from finish of an H-blank period that follows the last scanning signal (a scanning signal applied to scanning signal line GN-M in an example illustrated in FIG. 10) until start of input of the first scanning signal in a next frame (a scanning signal applied to scanning signal line G1-1 in the example illustrated in FIG. 10).

FIG. 11 is a timing chart of scanning signals and touch driving signals in one frame period in the PSR mode of driving method 2-1 in the second exemplary embodiment. As illustrated in FIG. 11, also in driving method 2-1, a V-blank period in the PSR mode is longer than a V-blank period in the normal mode.

As illustrated in FIG. 11, sensor control circuit 13 generates sensor signal in the same manner as in the normal mode also in the V-blank period during which liquid crystal panel 21 is not in operation. Sensor driving circuit 26 applies touch driving signals to driving electrodes 11 in response to the sensor signal input from sensor control circuit 13. The sensor signal may be generated not at the same timing as the timing in the normal mode, but at timing that differs from the timing in the normal mode in the V-blank period.

Further, a number of times of successively applying pulse voltage of touch driving signals to each of driving electrodes 11 in the V-blank period in the PSR mode is desirably equal to a number of times of successively applying pulse voltage during display update. For example, when pulse voltage is successively applied to each of driving electrodes 11 as touch driving signals n times during display update in the PSR mode, it is desirable to successively apply pulse voltage to each of driving electrodes 11 as touch driving signals n times also in the V-blank period. Accordingly, it is possible to prevent variation in the sensitivity of touch detection.

[2-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

In the same manner as in the first exemplary embodiment, the display device is configured so that scanning signals are generated based on the first timing signal generated depending on the operation mode and the second timing signal generated once per one frame and no first timing signal is generated in the V-blank period when the display device operates in the second mode (PSR mode). When determining that the display device operates in the first mode (normal mode), based on the PSR mode signal, the touch controller generates touch driving signals based on the first timing signal. On the other hand, when determining that the display device operates in the second mode (PSR mode), based on the PSR mode signal, the touch controller generates touch driving signals based on the first timing signal and generates touch driving signals also in the V-brank period during which no first timing signal is generated.

Further, the display device is configured to operate with the H-blank period provided in one horizontal scanning period, and no scanning signal is applied to scanning signal lines 10 in the H-blank period. When determining that the display device operates in the first mode (normal mode), the touch controller generates touch driving signals only in the H-blank periods. On the other hand, when determining that the display device operates in the second mode (PSR mode), the touch controller generates touch driving signals in the H-blank periods and the V-blank period.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the H-blank periods in the normal mode and generated only in the H-blank periods and the V-blank period in the PSR mode to perform the touch detection, thereby making it possible to perform the touch detection in a period during which display noise is reduced. Therefore, it is possible to further improve the sensitivity of the touch detection.

### Third Exemplary Embodiment

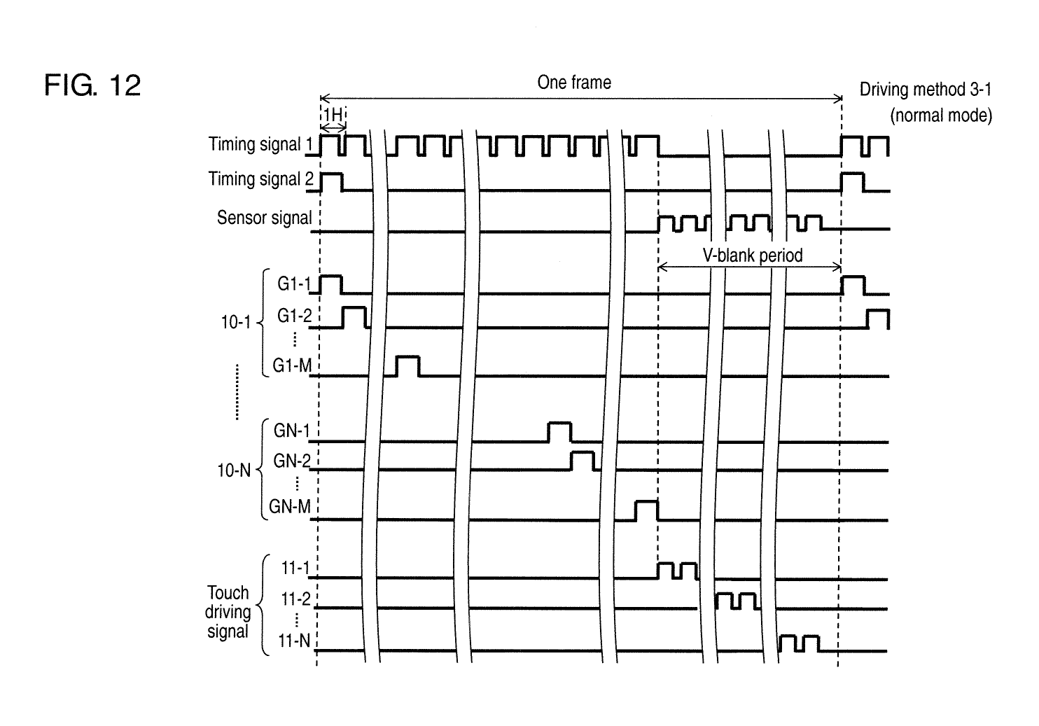

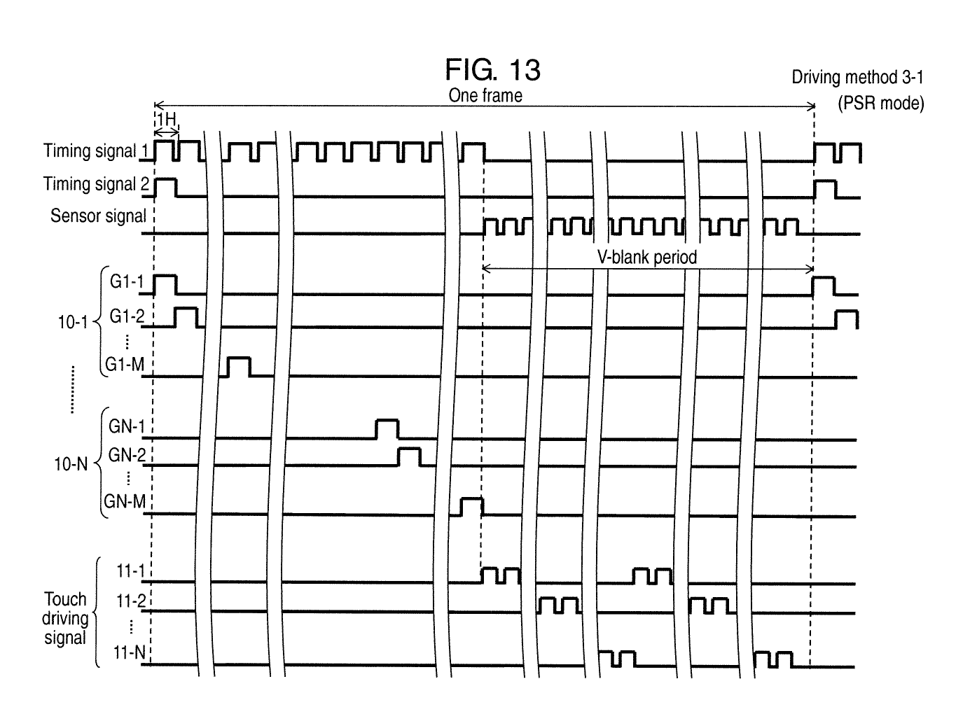

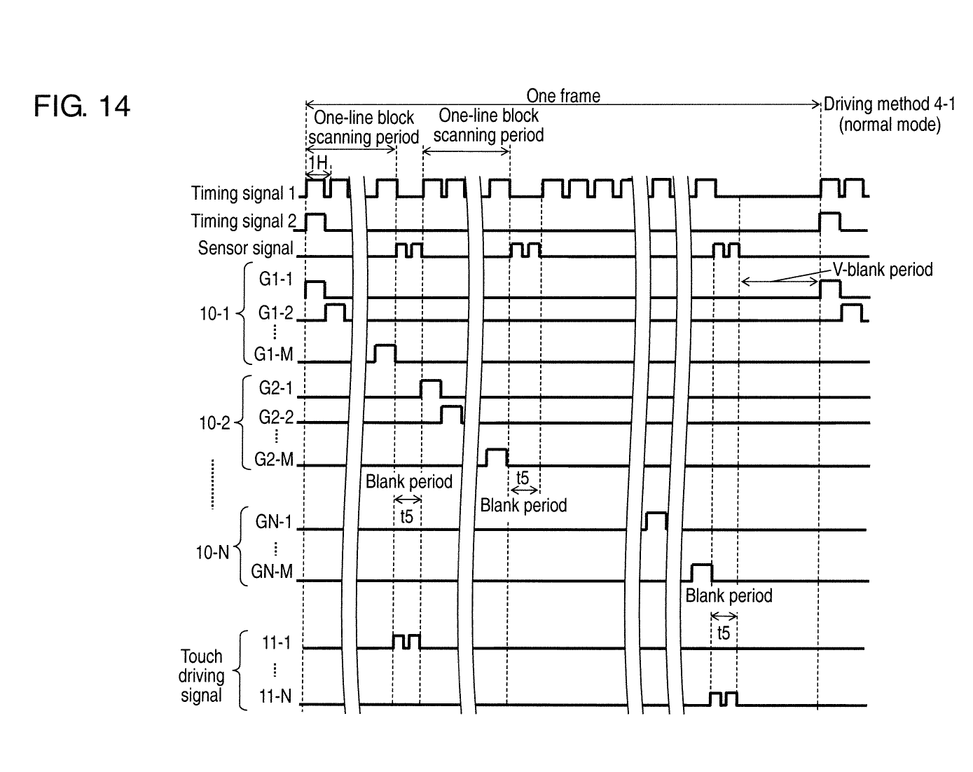

Next, an operation when a display device is driven by driving method 3-1 will be described with reference to FIG. 12 and FIG. 13.

[3-1. Configuration]

The display device in a third exemplary embodiment has substantially the same configuration as the configuration of display device 100 described in the first exemplary embodiment. Therefore, description of the configuration of the display device in the third exemplary embodiment will be omitted. Further, the operation mode of the display device is determined by the touch controller based on the PSR mode signal in the same manner as in the first exemplary embodiment. Therefore, description of this determination will be omitted.

[3-2. Operation]

FIG. 12 is a timing chart of scanning signals and touch driving signals in one frame period in a normal mode of driving method 3-1 in the third exemplary embodiment.

In driving method 3-1, touch detection is not performed during display update, that is, in a period during which scanning signals are applied to scanning signal lines 10, but performed in a V-blank period. Therefore, sensor control circuit 13 generates sensor signal only in the V-blank period. Sensor driving circuit 26 applies a touch driving signal to each of driving electrodes 11 only in the V-blank period in response to the sensor signal input from sensor control circuit 13.

The V-blank period in driving method 3-1 indicates a period from completion of output of a scanning signal that corresponds to last timing signal 1 (a scanning signal applied to scanning signal line GN-M in an example illustrated in FIG. 12) until start of input of the first scanning signal in a next frame (a scanning signal applied to scanning signal line G1-1 in the example illustrated in FIG. 12).

As illustrated in FIG. 12, in driving method 3-1, each scanning signal is made short so as to lengthen the V-blank period. During the V-blank period, a change in the scanning signal and a change in a video signal do not occur. Therefore, it is not necessary to take into consideration display noise in the V-blank period. Thus, in driving method 3-1, by performing transmission/reception of a touch signal during the V-blank period, the sensitivity of the touch sensor can be improved compared to driving method 1-1.

FIG. 13 is a timing chart of scanning signals and touch driving signals in one frame period in the PSR mode of driving method 3-1 in the third exemplary embodiment. As illustrated in FIG. 13, also in driving method 3-1, a V-blank period in the PSR mode is longer than a V-blank period in the normal mode.

As illustrated in FIG. 13, in the PSR mode in driving method 3-1, sensor control circuit 13 increases a number of sensor signals generated during the V-blank period so as to be larger than a number of sensor signals generated during the V-blank period in the normal mode to thereby increase a number of times of applying touch driving signals to driving electrodes 11 in order to prevent the following phenomenon. A frame rate in the PSR mode is lower than a frame rate in the normal mode. Therefore, if the number of sensor signals generated during the V-blank period in the PSR mode is equal to the number of sensor signals generated during the V-blank period in the normal mode, a report rate of the touch panel in the PSR mode becomes lower than a report rate in the normal mode.

In an example illustrated in FIG. 13, in order to prevent the report rate of the touch panel in the PSR mode from becoming lower than the report rate in the normal mode of FIG. 12, a plurality of successive pulse voltages are generated in two parts without successively generating pulse voltages of touch driving signals applied to the respective driving electrodes 11 at once. Therefore, in the normal mode, a report of a coordinate position detected in the entire one screen in the V-blank period is output once. On the other hand, in the PSR mode, a report of a coordinate position detected in the entire one screen in the V-blank period is output twice.

[3-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

The touch controller is configured to generate touch driving signals only in the V-blank period. Further, the touch controller is configured to generate more touch driving signals during the V-blank period when the display device operates in the second mode (PSR mode) than during the V-blank period when the display device operates in the first mode (normal mode).

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the V-blank period both in the normal mode and the PSR mode to perform the touch detection, thereby making it possible to perform the touch detection in a period during which display noise is reduced. Therefore, it is possible to further improve the sensitivity of the touch detection.

### Fourth Exemplary Embodiment

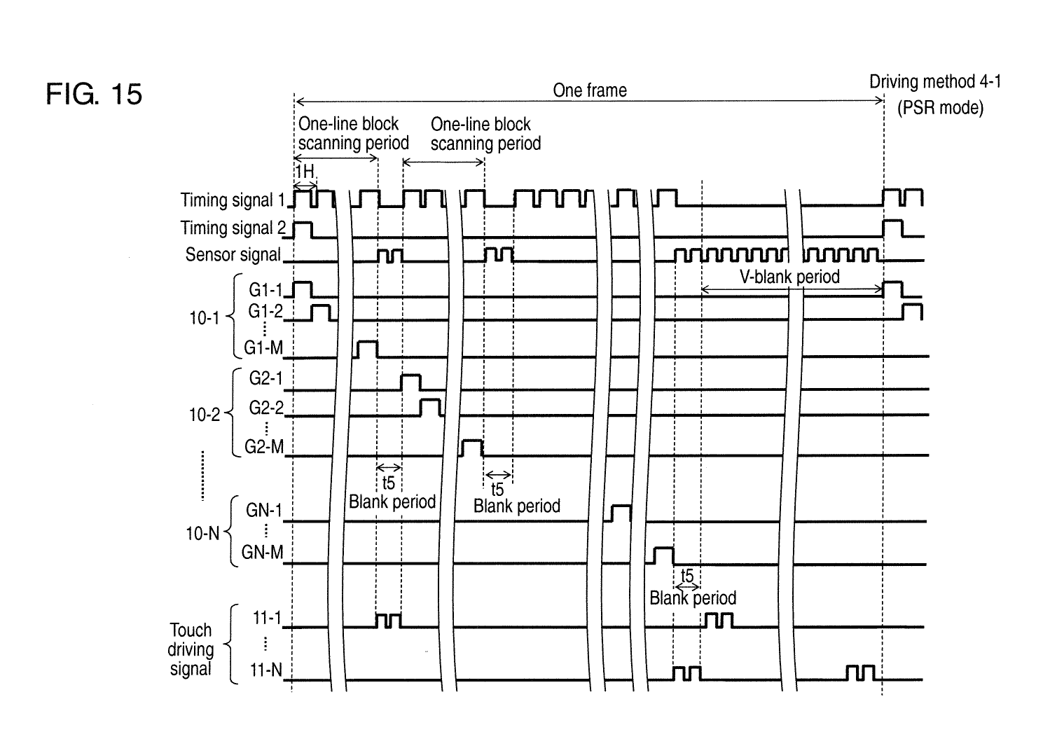

Next, an operation when a display device is driven by driving method 4-1 will be described with reference to FIG. 14 and FIG. 15.

[4-1. Configuration]

The display device in a fourth exemplary embodiment has substantially the same configuration as the configuration of display device 100 described in the first exemplary embodiment. Therefore, description of the configuration of the display device in the fourth exemplary embodiment will be omitted. Further, the operation mode of the display device is determined by the touch controller based on the PSR mode signal in the same manner as in the first exemplary embodiment. Therefore, description of this determination will be omitted.

[4-2. Operation]

FIG. 14 is a timing chart of scanning signals and touch driving signals in one frame period in a normal mode of driving method 4-1 in the fourth exemplary embodiment.

In driving method 4-1, blank periods t5 are each provided when scanning signals are applied to a predetermined number of scanning signal lines 10. In an example illustrated in FIG. 14, the predetermined number is a number of scanning signal lines 10 that constitute one line block (M, for example). Specifically, each of blank periods t5 is provided immediately after finish of each line block scanning period in such a manner that blank period t5 is provided immediately after finish of application of scanning signals to scanning signal lines G1-1 to G1-M that constitute line block 10-1, and blank period t5 is then provided immediately after finish of application of scanning signals to scanning signal lines G2-1 to G2-M that constitute line block 10-2. Then, a next line block scanning period is started after blank period t5, and scanning signals are sequentially applied to scanning signal lines 10 that constitute the next line block.

In this manner, in driving method 4-1, blank periods t5 are provided at the respective one-line block scanning periods (for example, between finish of scanning of line block 10-1 and start of scanning of line block 10-2). During blank periods t5, no scanning signal and no video signal is generated. Therefore, it is not necessary to take into consideration display noise in blank periods t5. Thus, in driving method 4-1, by applying a touch driving signal of sensor driving circuit 26 to each of driving electrodes 11 during each of blank periods t5 to perform transmission/reception of a touch signal, the sensitivity of the touch sensor can be improved compared to driving method 1-1.

In driving method 4-1 illustrated in FIG. 14, there is illustrated a sensor signal that generates two pulse voltages in each of blank periods t5. However, a number of pulse voltages generated in each of blank periods t5 is not limited at all to two, and may be optimally set depending on specification and the like of the display device.

A V-blank period in driving method 4-1 indicates a period from finish of last blank period t5 in one frame until start of input of the first scanning signal in a next frame (a scanning signal applied to scanning signal line G1-1 in the example illustrated in FIG. 14).

FIG. 15 is a timing chart of scanning signals and touch driving signals in one frame period in a PSR mode of driving method 4-1 in the fourth exemplary embodiment.

As illustrated in FIG. 15, also in driving method 4-1, a V-blank period in the PSR mode is longer than a V-blank period in the normal mode. In driving method 4-1, sensor control circuit 13 generates sensor signal also in the V-blank period, and allows sensor driving circuit 26 to apply touch driving signals to driving electrodes 11. The sensor signal in the V-blank period may be generated at different cycles from the normal mode.

[4-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

The display device is configured to operate with the blank periods each provided when scanning signals are applied to a predetermined number of scanning signal lines. The touch controller is configured to generate touch driving signals only in blank periods t5 when determining that the display device operates in the first mode (normal mode), based on the PSR mode signal, and configured to generate touch driving signals in blank periods t5 and the V-blank period when determining that the display device operates in the second mode (PSR mode), based on the PSR mode signal.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, the touch detection is performed only in blank periods t5 in the normal mode and performed only in blank periods t5 and the V-blank period in the PSR mode, thereby making it possible to perform the touch detection in a period during which display noise is reduced. Therefore, it is possible to further improve the sensitivity of the touch detection.

### Fifth Exemplary Embodiment

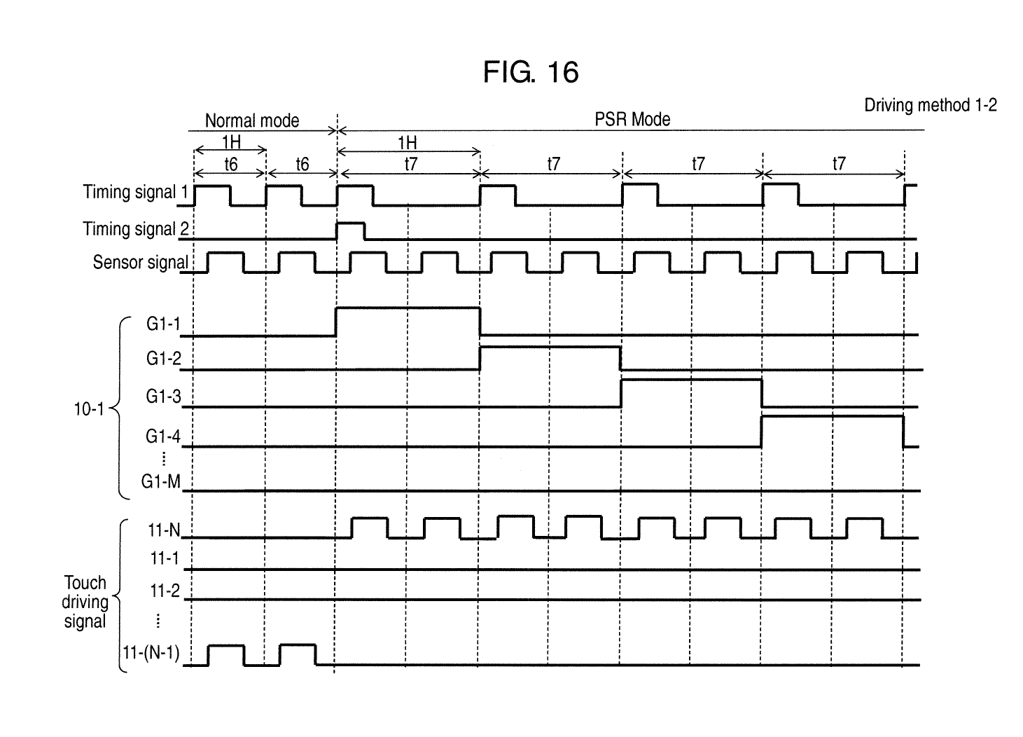

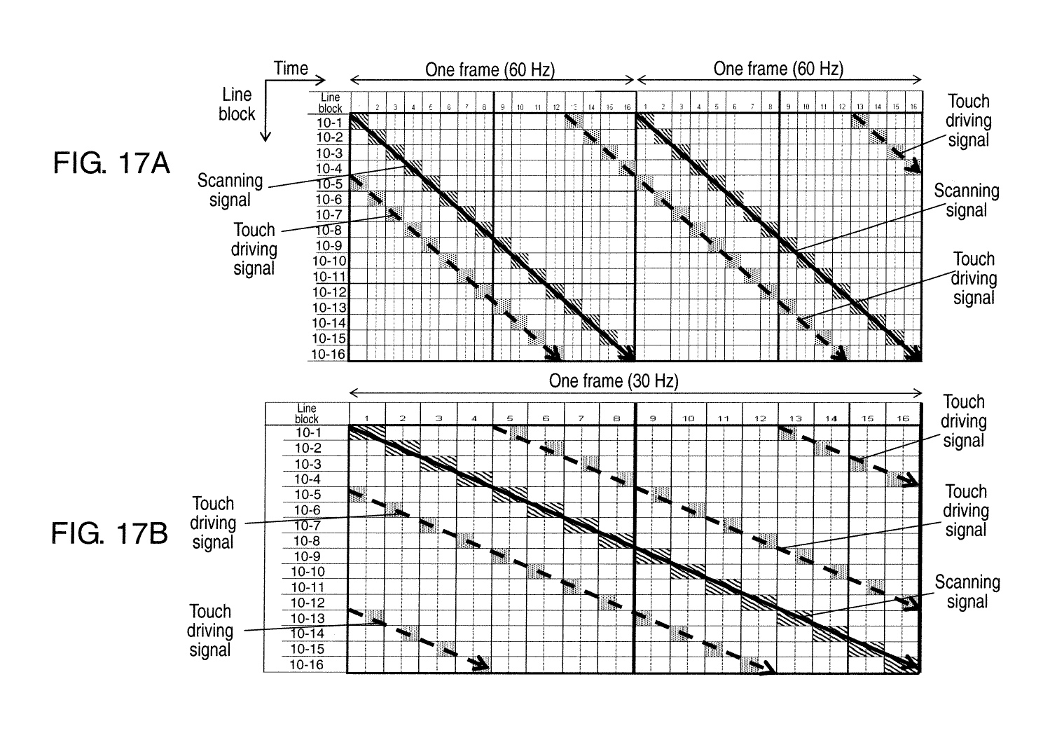

Next, an operation when a display device is driven by driving method 1-2 will be described with reference to FIG. 16, FIG. 17A, and FIG. 17B.

The driving method in the present exemplary embodiment illustrated in FIG. 16, FIG. 17A, and FIG. 17B is substantially the same as driving method 1-1 described in the first exemplary embodiment excepting the following points and is therefore referred to as driving method 1-2. Specifically, in driving method 1-2, a horizontal scanning period in a PSR mode is made longer than a horizontal scanning period in a normal mode. Further, in driving method 1-2, because a number of sensor signals to be generated is increased using the extension of the horizontal scanning period in the PSR mode, it is not necessary to generate a sensor signal in a V-blank period.

[5-1. Configuration]

The display device in the fifth exemplary embodiment has substantially the same configuration as the configuration of display device 100 described in the first exemplary embodiment. Therefore, description of the configuration of the display device in the fifth exemplary embodiment will be omitted. Further, the operation mode of the display device is determined by the touch controller based on the PSR mode signal in the same manner as in the first exemplary embodiment. Therefore, description of this determination will be omitted.

[5-2. Operation]

FIG. 16 is a timing chart of scanning signals and touch driving signals in the PSR mode of driving method 1-2 in the fifth exemplary embodiment. In FIG. 16, the V-blank period is omitted for simplifying explanation.

An operation in the normal mode of driving method 1-2 is substantially the same as the operation in the normal mode of driving method 1-1 described in the first exemplary embodiment. Therefore, description of the operation in the normal mode of driving method 1-2 will be omitted.

As illustrated in FIG. 16, in driving method 1-2, a pulse width of each scanning signal applied to each of scanning signal lines 10 in the PSR mode is longer than a pulse width of each scanning signal in the normal mode. FIG. 16 illustrates an example in which the display device operates at 60 Hz per one frame in the normal mode and operates at 30 Hz per one frame in the PSR mode. As illustrated in FIG. 16, when the pulse width of the scanning signal in the PSR mode, that is, time of one period of timing signal 1 is made twice the pulse width of the scanning signal in the normal mode, time per one frame in the PSR mode becomes approximately twice time per one frame in the normal mode (a frame rate of 30 Hz, for example).

Sensor control circuit 13 determines the operation mode of the display device based on the PSR mode signal.

In the example illustrated in FIG. 16, sensor control circuit 13 generates the sensor signal once in one horizontal scanning period t6 in the normal mode and generates the sensor signal twice in one horizontal scanning period t7 in the PSR mode. Therefore, sensor driving circuit 26 applies the touch driving signal to each of driving electrodes 11 once in one horizontal scanning period t6 in the normal mode and applies the touch driving signal to each of driving electrodes 11 twice in one horizontal scanning period t7 in the PSR mode. Because a length of horizontal scanning period t7 is approximately twice a length of horizontal scanning period t6, and, on the other hand, the transition period illustrated in FIG. 8 substantially remains unchanged, a touch detection period in the PSR mode is increased. As a result, the touch driving signal can be applied to each of driving electrodes 11 twice in one horizontal scanning period t7 in the above manner.

FIG. 17A is a timing chart illustrating, in a unit of line block, a relationship between supply of scanning signals to scanning signal lines 10 and supply of touch driving signals to driving electrodes 11 in the normal mode of driving method 1-2 in the fifth exemplary embodiment. FIG. 17B is a timing chart illustrating, in a unit of line block, a relationship between supply of scanning signals to scanning signal lines 10 and supply of touch driving signals to driving electrodes 11 in the PSR mode of driving method 1-2 in the fifth exemplary embodiment. FIG. 17A and FIG. 17B each illustrate a case in which a total number of line blocks is 16 (N=16) as an example. However, the number of line blocks is not limited at all to 16. As illustrated in FIG. 17A and FIG. 17B, scanning of scanning signal lines 10 is performed in the PSR mode at a speed half a speed in the normal mode.

In FIG. 17A and FIG. 17B, one square in a vertical axis represents one line block and one square in a horizontal axis represents one line block scanning period. In the present exemplary embodiment, a frame frequency in the PSR mode (30 Hz, for example) is set to be half a frame frequency in the normal mode (60 Hz, for example). Therefore, two frames in the normal mode illustrated in FIG. 17A are generated in one frame period in the PSR mode illustrated in FIG. 17B. Further, in FIG. 17A and FIG. 17B, order of applying scanning signals is indicated by solid lines and order of applying touch driving signals is indicated by broken lines. The timing charts illustrated in FIG. 17A and FIG. 17B are merely examples. Therefore, the present exemplary embodiment is not limited at all to the relationships illustrated in FIG. 17A and FIG. 17B.

In the normal mode, as illustrated in FIG. 17A using the solid lines, scanning signals are applied to scanning signal lines 10 in array order of the line blocks, that is, in such order as line block 10-1, 10-2, . . . , 10-16. Further, as illustrated in FIG. 17A using the broken lines, touch driving signals are applied to driving electrodes 11 in such order as driving electrode 11-5, 11-6, . . . , 11-16, 11-1, . . . , 11-4. An operation of sequentially applying touch driving signals to driving electrodes 11 is also referred to as “scanning for touch detection”.

In an example illustrated in FIG. 17A, three line blocks are interposed between a line block to which scanning signals are applied and driving electrode 11 to which a touch driving signal is applied, which differs from the operation example illustrated in FIG. 16. However, in the present exemplary embodiment, it is only required to prevent a touch driving signal from being applied to driving electrode 11 that corresponds to a line block to which scanning signals are applied in the same manner as in driving method 1-1 described in the first exemplary embodiment. Therefore, for example, the drive as illustrated in FIG. 16 may be performed, or the drive as illustrated in FIG. 17A may be performed.

In the PSR mode, as illustrated in FIG. 17B using the solid lines, scanning signals are applied to scanning signal lines 10 in the array order of the line blocks, that is, in such order as line block 10-1, 10-2, . . . , 10-16. This scanning order is the same as the scanning order in the normal mode illustrated in FIG. 17A. However, as can be understood from comparison between FIG. 17A and FIG. 17B, scanning for one screen is performed twice in the normal mode in a period during which scanning for one screen is performed once in the PSR mode. This is because of that the frame rate in the PSR mode is set to be half the frame rate in the normal mode.

On the other hand, in the PSR mode, as illustrated in FIG. 17B using the broken lines, touch driving signals are applied to driving electrodes 11 in such order as driving electrode 11-5, 11-6, . . . , 11-16, 11-1, . . . , 11-4 in the first half of each line block scanning period and in such order as driving electrode 11-13, . . . , 11-16, 11-1, . . . , 11-12 in the latter half of each line block scanning period. Accordingly, the scanning for one screen for touch detection is performed twice in one frame period in the PSR mode. As a result, the report rate of the touch panel in the PSR mode and the report rate of the touch panel in the normal mode can be made substantially equal to each other.

In FIG. 17B, one line block scanning period is divided into two parts, that is, the first half and the latter half because of the following reason. As illustrated in FIG. 16, horizontal scanning period t7 in the PSR mode is twice horizontal scanning period t6 in the normal mode. Therefore, a number of sensor signals that can be generated in the PSR mode is twice a number of sensor signals that can be generated in the normal mode. Thus, it is possible to divide one line block scanning period into the first half and the latter half, and to apply touch driving signals to different driving electrodes 11 in the respective half periods.

In the PSR mode, a number of sensor signals generated in the first half and a number of sensor signals generated in the latter half in one line block scanning period are each equal to a number of sensor signals generated in one line block scanning period in the normal mode. Therefore, in the PSR mode, even when one line block scanning period is divided into the first half and the latter half and touch driving signals are applied to different driving electrodes 11 in the respective half periods to perform the scanning for touch detection, there is no substantial difference caused in the accuracy of one report rate from the normal mode.

In the present exemplary embodiment, in order to make the report rate of the touch panel in the PSR mode and the report rate of the touch panel in the normal mode substantially equal to each other, it is necessary to perform the scanning for one screen for touch detection, that is, perform an operation of sequentially applying touch driving signals to all of driving electrodes 11 twice in one frame period in the PSR mode, the one frame period corresponding to two frames in the normal mode.

Further, in the PSR mode, in order to suppress influence of disturbance in an image caused by application of voltage to the driving electrode, it is desirable that the order of applying scanning signals and touch driving signals be set so that lines indicating the order of applying the scanning signals (lines indicated by the solid lines in FIG. 17B) and lines indicating the order of applying the touch driving signals (lines indicated by the broken lines in FIG. 17B) do not interest each other.

Therefore, in the present exemplary embodiment, one line block scanning signal period is divided into the first half and the latter half and touch driving signals are applied to different driving electrodes 11 in the respective half periods in the PSR mode. In this manner, as illustrated in FIG. 17B, the scanning for one screen for touch detection is performed in the first half of the line block scanning period and the scanning for one screen for touch detection is performed also in the latter half. As a result, the report rate of the touch panel in the PSR mode and the report rate of the touch panel in the normal mode can be made substantially equal to each other.

In FIG. 17A and FIG. 17B, when time in the normal mode indicates “16”, time in the PSR mode corresponds to “8”. However, at this point, the scanning for one screen for touch detection has been performed in the PSR mode. Therefore, timing of outputting a report of a coordinate position of a touched part in the PSR mode is substantially the same as timing in the normal mode.

The orders of applying the respective signals illustrated in FIG. 17A and FIG. 17B are merely examples. However, as described above, the orders of applying the respective signals are desirably set so that the order of applying the scanning signals indicated by the solid lines and the order of applying the touch driving signals indicated by the broken lines do not interest each other.

[5-3. Effect]

As described above, in the input device in the present exemplary embodiment, the touch controller is configured to determine the operation mode of the display device based on the PSR mode signal in the same manner as in the first exemplary embodiment. Specifically, when sensor control circuit 13 detects that the PSR mode signal switches from low level to high level, sensor control circuit 13 determines that the display device has shifted from the normal mode to PSR mode. Moreover, the signal control device of the display device is configured to generate the PSR mode signal which gives the touch controller notice of the operation mode of the display device in the same manner as in the first exemplary embodiment.

The touch controller is configured to generate more touch driving signals during one horizontal scanning period (one period of the first timing signal, for example) when determining based on the PSR mode signal that the display device operates in the second mode (PSR mode) than during one horizontal scanning period when the display device operates in the first mode (normal mode). Specifically, in the input device of the present exemplary embodiment, in horizontal scanning period t7 in the PSR mode, the touch controller generates touch driving signals twice as many as touch driving signals generated in horizontal scanning period t6 (a predetermined horizontal scanning period) in the normal mode.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

### Sixth Exemplary Embodiment

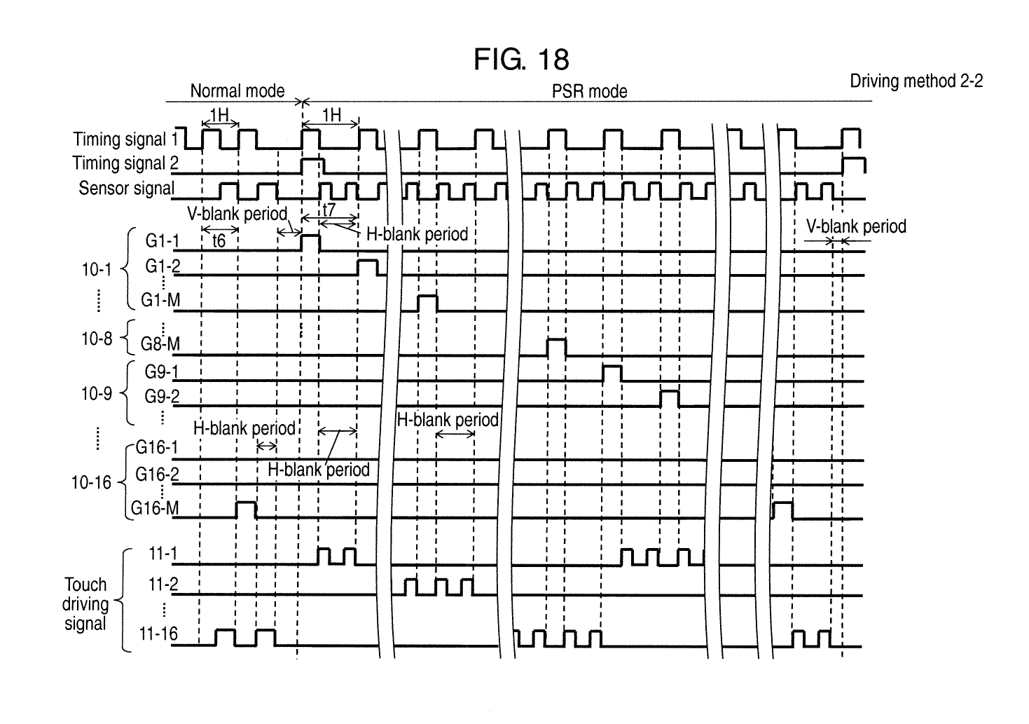

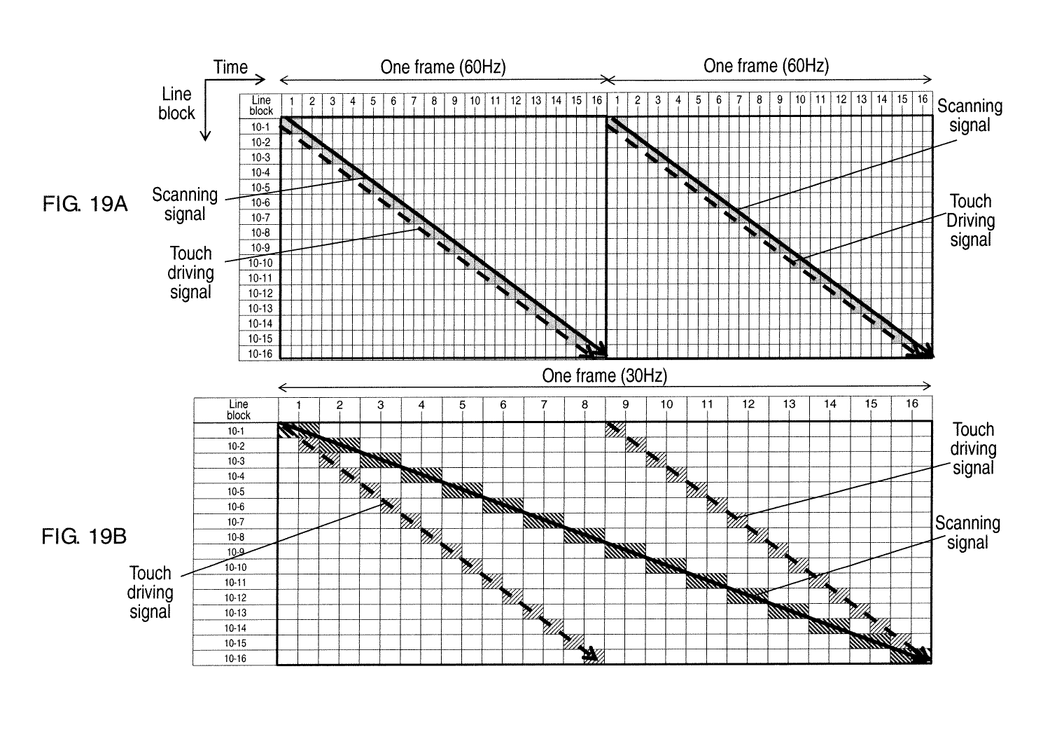

Next, an operation when a display device is driven by driving method 2-2 will be described with reference to FIG. 18, FIG. 19A and FIG. 19B.

The driving method in the present exemplary embodiment illustrated in FIG. 18, FIG. 19A and FIG. 19B is substantially the same as driving method 2-1 described in the second exemplary embodiment excepting the following points and is therefore referred to as driving method 2-2. Specifically, in driving method 2-2, an interval between scanning signals (H-blank period) in a PSR mode is made longer than an H-blank period in a normal mode. Further, in driving method 2-2, because a number of sensor signals to be generated is increased using the extension of the H-blank period in the PSR mode, it is not necessary to generate a sensor signal in a V-blank period.

[6-1. Configuration]

The display device in the sixth exemplary embodiment has substantially the same configuration as the configuration of display device 100 described in the first exemplary embodiment. Therefore, description of the configuration of the display device in the sixth exemplary embodiment will be omitted. Further, the operation mode of the display device is determined by the touch controller based on the PSR mode signal in the same manner as in the first exemplary embodiment. Therefore, description of this determination will be omitted.

[6-2. Operation]

FIG. 18 is a timing chart of scanning signals and touch driving signals in the PSR mode of driving method 2-2 in the sixth exemplary embodiment.

FIG. 18 illustrates an example of an operation when a total number of line blocks is 16 (N=16) in accordance with FIG. 19 A and FIG. 19B. However, the number of line blocks is not limited at all to 16.

An operation in the normal mode of driving method 2-2 is substantially the same as the operation in the normal mode of driving method 2-1 described in the second exemplary embodiment. Therefore, description of the operation in the normal mode of driving method 2-2 will be omitted.

As illustrated in FIG. 18, in driving method 2-2, one period of the scanning signals applied to scanning signal lines 10 (a period between a rising edge of a scanning signal and a rising edge of a next scanning signal) in the PSR mode is longer than one period of the scanning signals in the normal mode. FIG. 18 illustrates an example in which the display device operates at 60 Hz per one frame in the normal mode and operates at 30 Hz per one frame in the PSR mode. As illustrated in FIG. 18, when one period of the scanning signals in the PSR mode, that is, time of one period of timing signal 1 is made twice one period of the scanning signals in the normal mode, time per one frame in the PSR mode becomes approximately twice time per one frame in the normal mode (a frame rate of 30 Hz, for example).

Sensor control circuit 13 determines the operation mode of the display device based on the PSR mode signal.

As illustrated in FIG. 18, sensor control circuit 13 generates the sensor signal once within the H-blank period in the normal mode and generates the sensor signal twice within the H-blank period in the PSR mode. Therefore, sensor driving circuit 26 applies the touch driving signal to each of driving electrodes 11 once within the H-blank period in the normal mode and applies the touch driving signal to each of the electrodes 11 twice within the H-blank period in the PSR mode.

FIG. 19A is a timing chart illustrating, in a unit of line block, a relationship between supply of scanning signals to scanning signal lines 10 and supply of touch driving signals to driving electrodes 11 in the normal mode of driving method 2-2 in the sixth exemplary embodiment. FIG. 19B is a timing chart illustrating, in a unit of line block, a relationship between supply of scanning signals to scanning signal lines 10 and supply of touch driving signals to driving electrodes 11 in the PSR mode of driving method 2-2 in the sixth exemplary embodiment. FIG. 19A and FIG. 19B each illustrate a case in which a total number of line blocks is 16 (N=16) as an example. However, the number of line blocks is not limited at all to 16. As illustrated in FIG. 18, FIG. 19A, and FIG. 19B, scanning of scanning signal lines 10 is performed in the PSR mode at a speed half a speed in the normal mode.

Because FIG. 19A and FIG. 19B are illustrated in the same rule as FIG. 17A and FIG. 17B, description of FIG. 19A and FIG. 19B will be omitted. The timing charts illustrated in FIG. 19A and FIG. 19B are merely examples. Therefore, the present exemplary embodiment is not limited at all to the relationships illustrated in FIG. 19A and FIG. 19B.

In the normal mode, as illustrated in FIG. 19A using solid lines, scanning signals are applied to scanning signal lines 10 in array order of the line blocks, that is, in such order as line block 10-1, 10-2, . . . , 10-16. Further, as illustrated in FIG. 19A using broken lines, touch driving signals are applied to driving electrodes 11 in such order as driving electrode 11-1, 11-2, . . . , 11-16.

In the PSR mode, as illustrated in FIG. 19B using solid lines, scanning signals are applied to scanning signal lines 10 in the array order of the line blocks, that is, in such order as line block 10-1, 10-2, . . . , 10-16. This scanning order is the same as the scanning order in the normal mode illustrated in FIG. 19A. However, as can be understood from comparison between FIG. 19A and FIG. 19B, scanning for one screen is performed once in the PSR mode in a period during which scanning for one screen is performed twice in the normal mode. This is because of that the frame rate in the PSR mode is set to be half the frame rate in the normal mode.

On the other hand, in the PSR mode, as illustrated in FIG. 19B using broken lines, touch driving signals are applied to odd-numbered driving electrodes 11 in such order as driving electrode 11-1, 11-3, . . . , 11-15 in the first half of each line block scanning period and applied to even-numbered driving electrodes 11 in such order as driving electrode 11-2, 11-4, . . . , 11-16 in the latter half of each line block scanning period. Accordingly, as illustrated in FIG. 19B using the broken lines, the scanning for one screen for touch detection is performed in each of the first and latter halves of one frame in the PSR mode. This touch detection operation in the PSR mode is substantially the same as a touch detection operation in the normal mode. As a result, the report rate of the touch panel in the PSR mode and the report rate of the touch panel in the normal mode can be made substantially equal to each other.

In FIG. 19B, one line block scanning period is divided into two parts, that is, the first half and the latter half because of the following reason. As illustrated in FIG. 18, a number of sensor signals that can be generated in the H-blank period in the PSR mode is twice a number of sensor signals generated in the H-blank period in the normal mode. Therefore, it is possible to divide one line block scanning period into the first half and the latter half, and to apply touch driving signals to different driving electrodes 11 in the respective half periods.

In the PSR mode, a number of sensor signals generated in the first half and a number of sensor signals generated in the latter half in one line block scanning period are each equal to a number of sensor signals generated in one line block scanning period in the normal mode. Therefore, in the PSR mode, even when one line block scanning period is divided into the first half and the latter half and touch driving signals are applied to different driving electrodes 11 in the respective half periods to perform the scanning for touch detection, there is no substantial difference caused in the accuracy of one report rate from the normal mode.

In FIG. 19A and FIG. 19B, when time in the normal mode indicates “16”, time in the PSR mode corresponds to “8”. However, at this point, the scanning for one screen for touch detection has been performed in the PSR mode. Therefore, timing of outputting a report of a coordinate position of a touched part in the PSR mode is substantially the same as timing in the normal mode.

The orders of applying the respective signals illustrated in FIG. 19A and FIG. 19B are merely examples, and the present exemplary embodiment is not limited at all to these orders.

[6-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

The touch controller is configured to generate more touch driving signals during one horizontal scanning period (one period of the first timing signal, for example) when determining based on the PSR mode signal that the display device operates in the second mode (PSR mode) than during one horizontal scanning period when the display device operates in the first mode (normal mode).

Further, the touch controller is configured to generate touch driving signals only in the H-blank periods both when the display device operates in the first mode (normal mode) and when the display device operates in the second mode (PSR mode). For example, in each of the H-blank periods in the PSR mode, the sensor control circuit generates touch driving signals twice as many as touch driving signals generated in the H-blank period in the normal mode.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the H-blank periods both in the normal mode and the PSR mode to perform the touch detection, thereby making it possible to perform the touch detection in a period during which display noise is reduced. Therefore, it is possible to further improve the sensitivity of the touch detection.

### Seventh Exemplary Embodiment

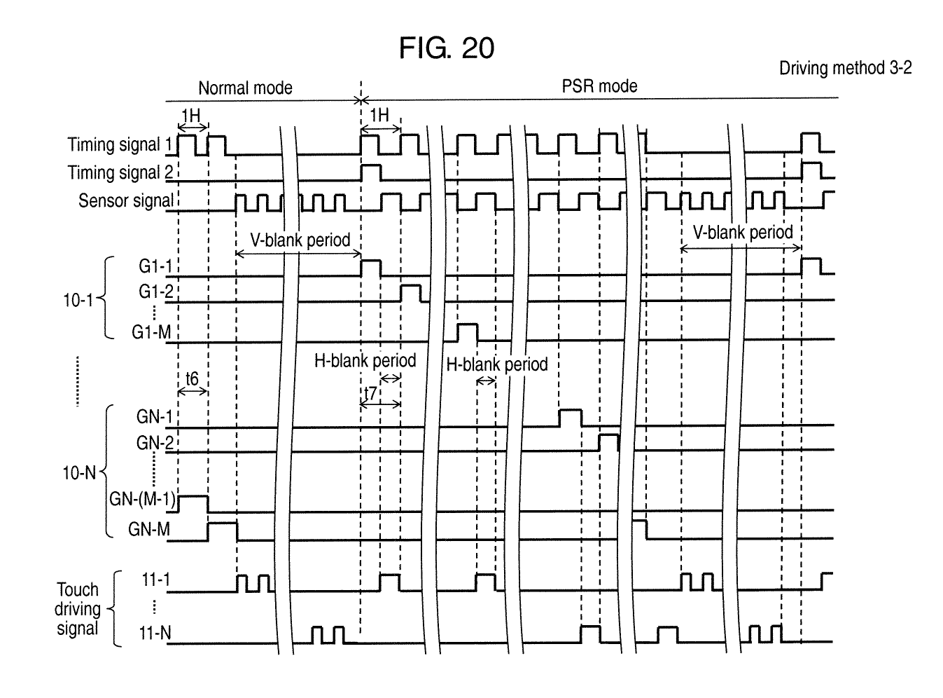

Next, an operation when a display device is driven by driving method 3-2 will be described with reference to FIG. 20.

The driving method in the present exemplary embodiment illustrated in FIG. 20 is substantially the same as driving method 3-1 described in the third exemplary embodiment excepting the following points and is therefore referred to as driving method 3-2. Specifically, in driving method 3-2, an H-blank period between scanning signals in a PSR mode is made longer than an H-blank period in a normal mode. Further, in driving method 3-2, sensor signal is generated by using the extension of the H-blank period in the PSR mode. Therefore, a number of sensor signals generated during a V-blank period in the PSR mode may be equal to a number of sensor signals generated during a V-blank period in the normal mode. In the present exemplary embodiment, a length of the V-blank period in the PSR mode is substantially equal to a length of the V-blank period in the normal mode.

[7-1. Configuration]

The display device in the seventh exemplary embodiment has substantially the same configuration as the configuration of display device 100 described in the first exemplary embodiment. Therefore, description of the configuration of the display device in the seventh exemplary embodiment will be omitted. Further, the operation mode of the display device is determined by the touch controller based on the PSR mode signal in the same manner as in the first exemplary embodiment. Therefore, description of this determination will be omitted.

[7-2. Operation]

FIG. 20 is a timing chart of scanning signals and touch driving signals in the PSR mode of driving method 3-2 in the seventh exemplary embodiment.

An operation in the normal mode of driving method 3-2 is substantially the same as the operation in the normal mode of driving method 3-1 described in the third exemplary embodiment. Therefore, description of the operation in the normal mode of driving method 3-2 will be omitted.

As illustrated in FIG. 20, in driving method 3-2, one period of the scanning signals applied to scanning signal lines 10 (a period between a rising edge of a scanning signal and a rising edge of a next scanning signal) in the PSR mode is longer than one period of the scanning signals in the normal mode. FIG. 20 illustrates an example in which the display device operates at 60 Hz per one frame in the normal mode and operates at 30 Hz per one frame in the PSR mode. As illustrated in FIG. 20, when one period of the scanning signals in the PSR mode, that is, time of one period of timing signal 1 is made twice one period of the scanning signals in the normal mode, time per one frame in the PSR mode becomes approximately twice time per one frame in the normal mode (a frame rate of 30 Hz, for example).

Sensor control circuit 13 determines the operation mode of the display device based on the PSR mode signal.

As illustrated in FIG. 20, sensor control circuit 13 controls sensor driving circuit 26 so as to apply touch driving signals to driving electrodes 11 only in the V-blank period in the normal mode. However, as illustrated in FIG. 20, sensor control circuit 13 generates sensor signal so that sensor driving circuit 26 applies touch driving signals to driving electrodes 11 not only in the V-blank period, but also in the H-blank periods in the PSR mode.

As a result, the report rate of the touch panel in the PSR mode and the report rate of the touch panel in the normal mode can be made substantially equal to each other.

[7-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

Further, the touch controller is configured to generate touch driving signals only in the V-blank period when determining that the display device operates in the first mode (normal mode), based on the PSR mode signal, and configured to generate touch driving signals both in the H-blank periods and the V-blank period when determining that the display device operates in the second mode (PSR mode), based on the PSR mode signal.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the V-blank period in the normal mode and generated only in both the H-blank periods and the V-blank period in the PSR mode to perform the touch detection, thereby making it possible to perform the touch detection in a period during which display noise is reduced. Therefore, it is possible to further improve the sensitivity of the touch detection.

### Eighth Exemplary Embodiment

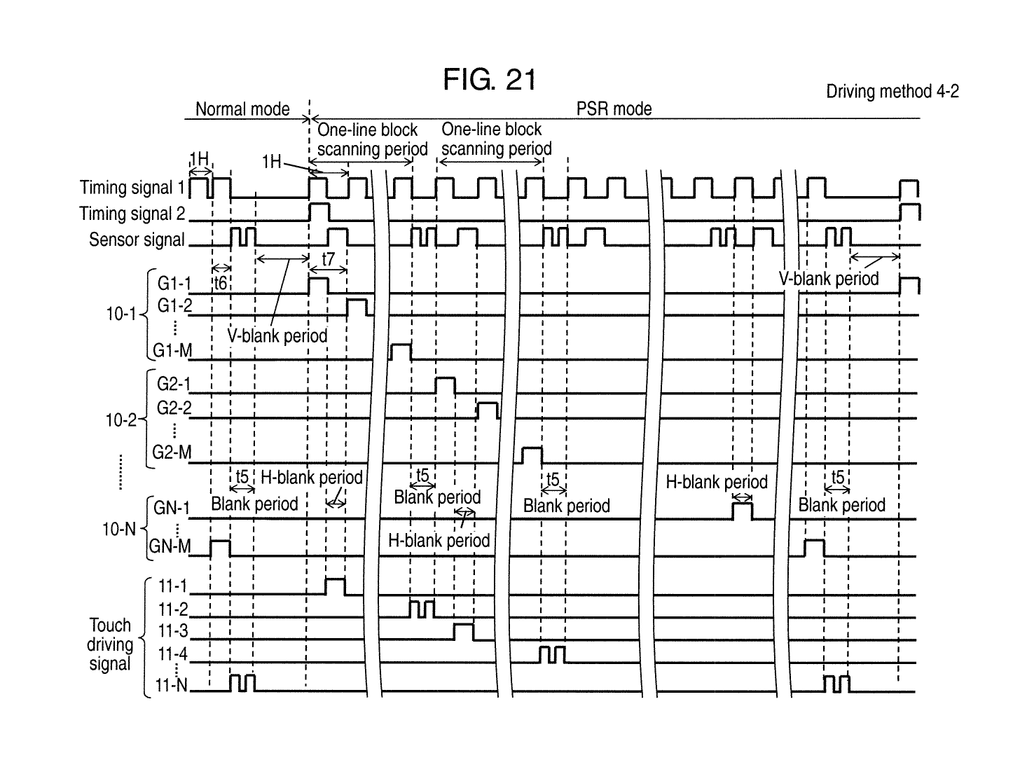

Next, an operation when a display device is driven by driving method 4-2 will be described with reference to FIG. 21.

The driving method in the present exemplary embodiment illustrated in FIG. 21 is substantially the same as driving method 4-1 described in the fourth exemplary embodiment excepting the following points and is therefore referred to as driving method 4-2. Specifically, in driving method 4-2, an H-blank period between scanning signals in a PSR mode is made longer than an H-blank period in a normal mode. Further, in driving method 4-2, because sensor signal is generated by using the extension of the H-blank period in the PSR mode, it is not necessary to generate a sensor signal in a V-blank period.

[8-1. Configuration]

The display device in the eighth exemplary embodiment has substantially the same configuration as the configuration of display device 100 described in the first exemplary embodiment. Therefore, description of the configuration of the display device in the eighth exemplary embodiment will be omitted. Further, the operation mode of the display device is determined by the touch controller based on the PSR mode signal in the same manner as in the first exemplary embodiment. Therefore, description of this determination will be omitted.

[8-2. Operation]

FIG. 21 is a timing chart of scanning signals and touch driving signals in the PSR mode of driving method 4-2 in the eighth exemplary embodiment.

An operation in the normal mode of driving method 4-2 is substantially the same as the operation in the normal mode of driving method 4-1 described in the fourth exemplary embodiment. Therefore, description of the operation in the normal mode of driving method 4-2 will be omitted.

As illustrated in FIG. 21, in driving method 4-2, one period of the scanning signals applied to scanning signal lines 10 (a period between a rising edge of a scanning signal and a rising edge of a next scanning signal) in the PSR mode is longer than one period of the scanning signals in the normal mode. FIG. 21 illustrates an example in which the display device operates at 60 Hz per one frame in the normal mode and operates at 30 Hz per one frame in the PSR mode. As illustrated in FIG. 21, when one period of the scanning signals in the PSR mode, that is, time of one period of timing signal 1 is made twice one period of the scanning signals in the normal mode, time per one frame in the PSR mode becomes approximately twice time per one frame in the normal mode (a frame rate of 30 Hz, for example).

Sensor control circuit 13 determines the operation mode of the display device based on the PSR mode signal.

As illustrated in FIG. 21 (or as illustrated in FIG. 14), sensor control circuit 13 generates sensor signal in blank periods t5 each of which is provided between line block scanning periods and also provided immediately after finish of the last line block scanning period in one frame to thereby control sensor driving circuit 26 in the normal mode. However, as illustrated in FIG. 21, sensor control circuit 13 generates sensor signal also within the H-blank periods in addition to blank periods t5 in the PSR mode. Therefore, sensor driving circuit 26 can apply touch driving signals to driving electrodes 11 also within the H-blank periods in addition to blank periods t5 in the PSR mode.

Specifically, in the H-blank periods, touch driving signals are sequentially applied to odd-numbered driving electrodes 11 in such order as driving electrode 11-1, 11-3, . . . , 11-(N−1). Further, in blank periods t5, touch driving signals are sequentially applied to even-numbered driving electrodes 11 in such order as 11-2, 11-4, . . . , 11-N. Accordingly, touch driving signals can be sequentially applied to driving electrodes 11 for one screen in a period during which scanning signals are sequentially applied to scanning signal lines 10 for a half screen. That is, an operation of sequentially applying touch driving signals to driving electrodes 11 for one screen can be repeatedly performed twice in a period during which scanning signals are sequentially applied to scanning signal lines 10 for one screen (one frame period in the PSR mode).

The order of applying touch driving signals to driving electrodes 11 is not limited at all to the above order. It is only required that the operation of sequentially applying touch driving signals to driving electrodes 11 for one screen can be repeatedly performed twice in one frame period in the PSR mode.

As a result, the report rate of the touch panel in the PSR mode and the report rate of the touch panel in the normal mode can be made substantially equal to each other.

[8-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

Further, the display device is configured to operate with the blank periods each provided when scanning signals are applied to a predetermined number of scanning signal lines. The touch controller is configured to generate touch driving signals only in the blank periods when determining that the display device operates in the first mode (normal mode), based on the PSR mode signal, and configured to generate the touch driving signals both in the blank periods and the H-blank periods when determining that the display device operates in the second mode (PSR mode), based on the PSR mode signal.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the blank periods in the normal mode and generated only in both the blank periods and the H-blank periods in the PSR mode to perform the touch detection, thereby making it possible to perform the touch detection in a period during which display noise is reduced. Therefore, it is possible to further improve the sensitivity of the touch detection.

### Ninth Exemplary Embodiment

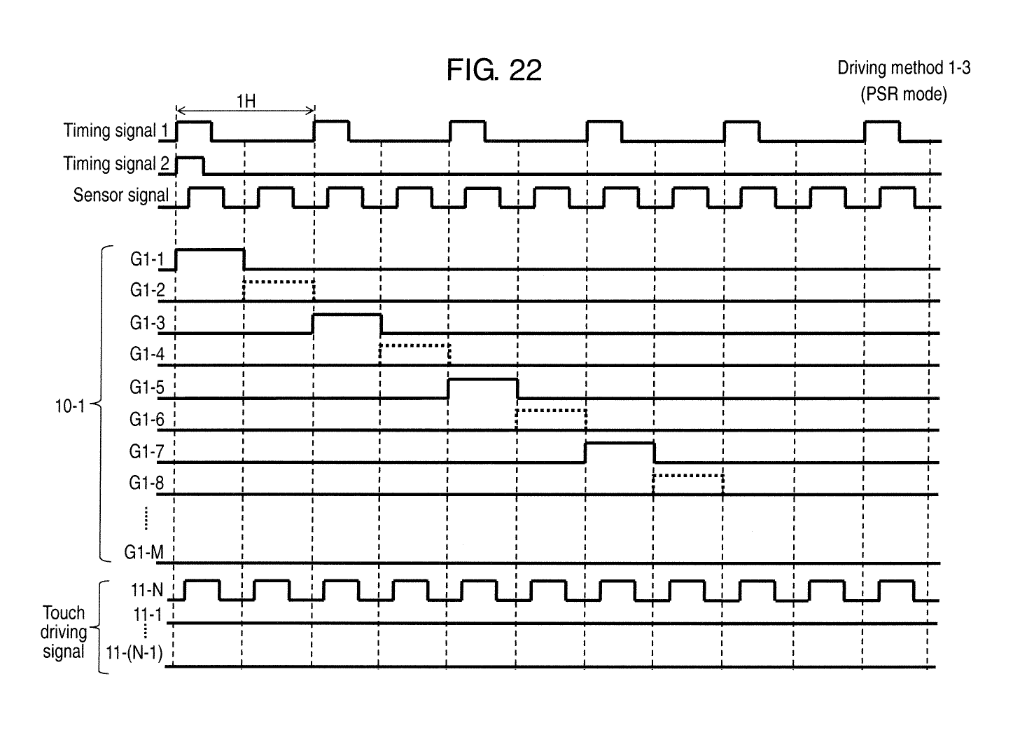

Next, an operation when a display device is driven by driving method 1-3 will be described with reference to FIG. 22.

The driving method in the present exemplary embodiment illustrated in FIG. 22 is substantially the same as driving method 1-1 described in the first exemplary embodiment excepting the following points and is therefore referred to as driving method 1-3. Specifically, in driving method 1-3, the display device performs drive in which scanning signals are applied non-sequentially to scanning signal lines 10 (interlace drive, for example) in a PSR mode. Further, in driving method 1-3, sensor signal is generated using time of a standby state during the interlace drive in the PSR mode. Therefore, it is not necessary to generate a sensor signal in a V-blank period.

The interlace drive indicates drive that alternately repeats an operation of sequentially applying scanning signals to odd-numbered scanning signal lines 10 and an operation of sequentially applying scanning signals to even-numbered scanning signal lines 10. However, the above “drive in which the display device applies scanning signals non-sequentially to scanning signal lines 10” is not limited at all to the interlace drive.

[9-1. Configuration]

The display device in the ninth exemplary embodiment has substantially the same configuration as the configuration of display device 100 described in the first exemplary embodiment. Therefore, description of the configuration of the display device in the ninth exemplary embodiment will be omitted. Further, the operation mode of the display device is determined by the touch controller based on the PSR mode signal in the same manner as in the first exemplary embodiment. Therefore, description of this determination will be omitted.

[9-2. Operation]

FIG. 22 is a timing chart of scanning signals and touch driving signals in the PSR mode of driving method 1-3 in the ninth exemplary embodiment. In FIG. 22, the V-blank period is omitted for simplifying explanation.

An operation in a normal mode of driving method 1-3 is substantially the same as the operation in the normal mode of driving method 1-1 described in the first exemplary embodiment. Therefore, description of the operation in the normal mode of driving method 1-3 will be omitted.

As illustrated in FIG. 22, in the interlace drive in the PSR mode of driving method 1-3, first, scanning signals are sequentially applied to scanning signal lines 10 in an odd-numbered row, that is, every other scanning signal lines from scanning signal line G1-1, specifically, in such order as scanning signal line G1-1, G1-3, G1-5, . . . , GN-(M−1). A first field is finished in this manner. Then, scanning signals are sequentially applied to scanning signal lines 10 in an even-numbered row, that is, every other scanning signal lines from scanning signal line G1-2, specifically, in such order as scanning signal line G1-2, G1-4, G1-6, . . . GN-M. A second field is finished in this manner. In the interlace drive, the first field and the second field constitute one frame. Therefore, when these series of operations are finished, the entire screen of the display device has been updated. In an example illustrated in FIG. 22, the display device operates at a frame frequency of 60 Hz in the normal mode and operates at a field frequency of 60 Hz in the PSR mode. In this case, an operation in the PSR mode corresponds to 30 Hz when converted into a frame frequency that indicates how many times display update for one screen is performed per second.

In the ninth exemplary embodiment and the subsequent exemplary embodiments, description will be made by taking, as an example, interlace drive in which one frame is composed of the first field in which scanning of the odd-numbered row is performed and the second field in which scanning of the even-numbered row is performed. However, such interlace drive is merely an example of the interlace drive in the PSR mode, and the present exemplary embodiment is not limited at all to this configuration. For example, the following interlace drive may be performed in the display device during the PSR mode. First, scanning signals are sequentially applied to every third scanning signal lines from scanning signal line G1-1, specifically, in such order as scanning signal line G1-1, G1-4, G1-7, . . . , and one field is thereby finished. Then, scanning signals are sequentially applied to every third scanning signal lines from scanning signal line G1-2, specifically, in such order as scanning signal line G1-2, G1-5, G1-8, . . . , and a next one field is thereby finished. Then, scanning signals are sequentially applied to every third scanning signal lines from scanning signal line G1-3, specifically, in such order as scanning signal line G1-3, G1-6, G1-9, . . . , and a next one field is thereby finished. In this case, the three fields constitute one frame. Therefore, when these series of operations are finished, one screen of the display device has been updated. In the case of this example, when the display device operates at a field frequency of 60 Hz, an operation in the PSR mode corresponds to approximately 20 Hz when converted into a frame frequency.

Sensor control circuit 13 determines the operation mode of the display device based on the PSR mode signal.

In the case of FIG. 22, after the application of a scanning signal to scanning signal line G1-1, when a scanning signal is applied to scanning signal line G1-2 in the normal mode as indicated by a broken line in FIG. 22, no timing signal 1 is input to scanning line driving circuit 23. Therefore, unlike the normal mode, no scanning signal is applied to scanning signal line G1-2 immediately after the application of a scanning signal to scanning signal line G1-1 in the PSR mode. Thus, during a period when a scanning signal is applied to scanning signal line G1-2 in the normal mode, the display device is in a standby state in the PSR mode.

In the PSR mode, sensor control circuit 13 generates sensor signal also in periods of a standby state indicated by broken lines in FIG. 22 (periods during which scanning signals are applied to scanning signal lines 10 in the even-numbered row including scanning signal lines G1-2, G1-4, G1-6 and the like in the normal mode) in addition to periods during which scanning signals are applied to scanning signal lines 10 in the odd-numbered row including scanning signal lines G1-1, G1-3, G1-5 and the like. Sensor driving circuit 26 applies touch driving signals to driving electrodes 11 in response to the sensor signal. Although not illustrated, in a next field, sensor control circuit 13 generates sensor signal also in the periods of a standby state (periods during which scanning signals are applied to scanning signal lines 10 in the odd-numbered row including scanning signal lines G1-1, G1-3, G1-5 and the like in the normal mode) in addition to the periods during which scanning signals are applied to scanning signal lines 10 in the even-numbered row including scanning signal lines G1-2, G1-4, G1-6, G1-8 and the like in the same manner as above. Sensor driving circuit 26 applies touch driving signals to driving electrodes 11 in response to the sensor signal.

Accordingly, the scanning for one screen for touch detection can be performed in each of the first and second fields which constitute one frame in the PSR mode. This touch detection operation in the PSR mode is substantially the same as a touch detection operation in the normal mode. As a result, the report rate of the touch panel in the PSR mode and the report rate of the touch panel in the normal mode can be made substantially equal to each other.

[9-3. Effect]

As described above, in the input device in the present exemplary embodiment, the touch controller is configured to determine the operation mode of the display device based on the PSR mode signal in the same manner as in the first embodiment. Specifically, when the sensor control circuit detects that the PSR mode signal switches from low level to high level, the sensor control circuit determines that the display device has shifted from the normal mode to the PSR mode. Moreover, the signal control device of the display device is configured to generate the PSR mode signal which gives the touch controller notice of the operation mode of the display device in the same manner as in the first exemplary embodiment.

Further, the display device is configured to apply scanning signals non-sequentially to scanning signal lines 10 (operates in the interlace drive, for example) in a second mode (PSR mode). The touch controller is configured to generate more touch driving signals during one horizontal scanning period (one period of the first timing signal, for example) when determining based on the PSR mode signal that the display device operates in the second mode (PSR mode) than during one horizontal scanning period when the display device operates in the first mode (normal mode). Specifically, when the interlace drive is performed in the display device, the touch controller generates touch driving signals also in the periods of a standby state during which no scanning signal is applied to scanning signal lines 10 in addition to the periods during which scanning signals are applied to scanning signal lines 10. In this manner, in the input device of the present exemplary embodiment, when the display device is interlace-driven, the touch detection is performed using time generated by the interlace drive.

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

### Tenth Exemplary Embodiment

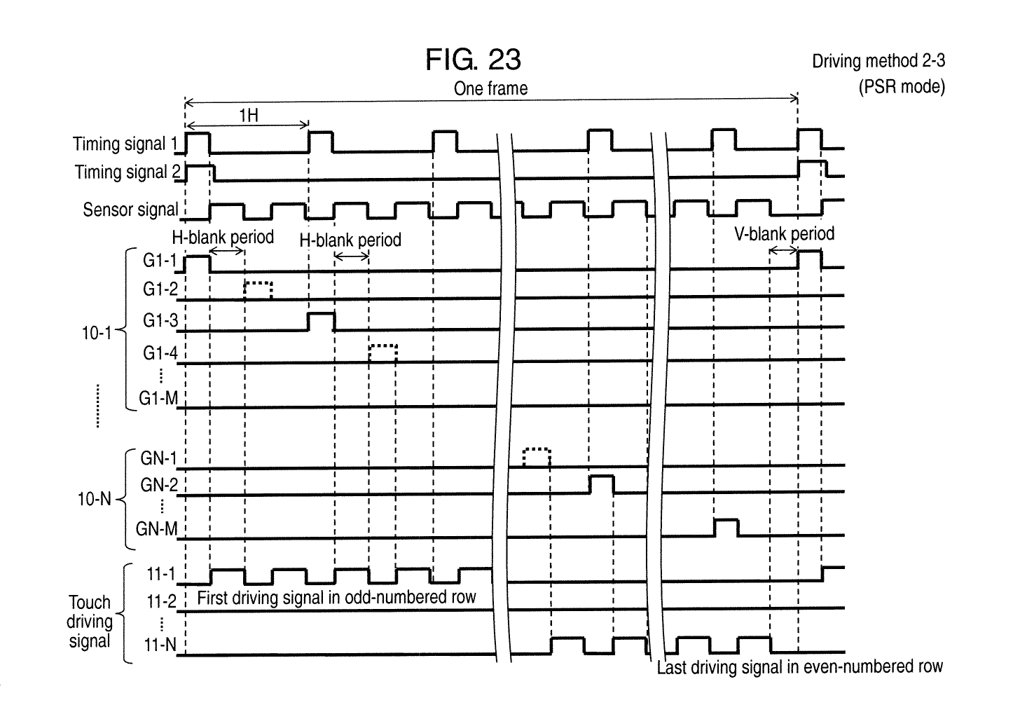

Next, an operation when a display device is driven by driving method 2-3 will be described with reference to FIG. 23.

The driving method in the present exemplary embodiment illustrated in FIG. 23 is substantially the same as driving method 2-1 described in the second exemplary embodiment excepting the following points and is therefore referred to as driving method 2-3. Specifically, in driving method 2-3, the display device is interlace-driven in a PSR mode. Further, in driving method 2-3, sensor signal is generated using time of standby state during the interlace drive in the PSR mode. Therefore, it is not necessary to generate a sensor signal in a V-blank period.

[10-1. Configuration]

The display device in a tenth exemplary embodiment has substantially the same configuration as the configuration of display device 100 described in the first exemplary embodiment. Therefore, description of the configuration of the display device in the tenth exemplary embodiment will be omitted. Further, the operation mode of the display device is determined by the touch controller based on the PSR mode signal in the same manner as in the first exemplary embodiment. Therefore, description of this determination will be omitted.

[10-2. Operation]

FIG. 23 is a timing chart of scanning signals and touch driving signals in the PSR mode of driving method 2-3 in the tenth exemplary embodiment.

An operation in a normal mode of driving method 2-3 is substantially the same as the operation in the normal mode of driving method 2-1 described in the second exemplary embodiment. Therefore, description of the operation in the normal mode of driving method 2-3 will be omitted.

An operation itself of the interlace drive illustrated in FIG. 23 is substantially the same as the operation of the interlace drive described in the ninth exemplary embodiment in which scanning is separately performed in scanning signal lines 10 in the odd-numbered row and scanning signal lines 10 in the even-numbered row. Therefore, the operation of the interlace drive illustrated in FIG. 23 will be omitted. In an example illustrated in FIG. 23, the display device operates at a frame frequency of 60 Hz in the normal mode and operates at a field frequency of 60 Hz in the PSR mode. Therefore, an operation in the PSR mode corresponds to 30 Hz when converted into a frame frequency.

As described in the second exemplary embodiment, in the normal mode of the present driving method, an H-blank period is provided between finish of application of a scanning signal to scanning signal line 10 (scanning signal line G1-1, for example) and start of application of a scanning signal to the next scanning signal line 10 (scanning signal line G1-2, for example). Also in the interlace drive in the PSR mode of driving method 2-3, each H-blank period is provided at the same timing as the timing in the normal mode.

In the PSR mode, as indicated by broken lines in FIG. 23, after finish of application of a scanning signal to scanning signal line 10 in an odd-numbered row (scanning signal line G1-1, for example), a period of a standby state is provided in the same manner as in the ninth exemplary embodiment without applying a scanning signal to adjacent scanning signal line 10 in an even-numbered row (scanning signal line G1-2, for example). In the PSR mode of the present exemplary embodiment, an H-blank period is provided between the finish of the application of a scanning signal to scanning signal line 10 and the standby state. Further, an H-blank period is provided also between finish of the standby state indicated by a broken line and application of a scanning signal to the next scanning signal line 10 (scanning signal line G1-3, for example). Sensor control circuit 13 generates sensor signal in the H-blank periods. Therefore, in the present exemplary embodiment, timing of generating sensor signal and a number of sensor signals to be generated (a number of sensor signals generated during one frame in the normal mode and a number of sensor signals generated during one field in the PSR mode) are each substantially the same between the normal mode and the PSR mode.

Sensor control circuit 13 determines the operation mode of the display device based on the PSR mode signal.

When determining based on the PSR mode signal that the display device has shifted from the normal mode to the PSR mode, sensor control circuit 13 generates sensor signal in the H-blank periods each between the finish of application of a scanning signal to scanning signal line 10 and the standby state indicated by a broken line in FIG. 23. Sensor driving circuit 26 applies touch driving signals to driving electrode 11 in response to the sensor signal input from sensor control circuit 13.

Accordingly, in the PSR mode, the scanning for one screen for touch detection can be performed in each of the first and second fields which constitute one frame in the same manner as in one frame period in the normal mode. As a result, the report rate of the touch panel in the PSR mode and the report rate of the touch panel in the normal mode can be made substantially equal to each other.

[10-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

Further, the display device is configured to apply scanning signals non-sequentially to scanning signal lines 10 (operates in the interlace drive, for example) in a second mode (PSR mode). The touch controller is configured to generate more touch driving signals during one horizontal scanning period (one period of the first timing signal, for example) when determining based on the PSR mode signal that the display device operates in the second mode (PSR mode) than during one horizontal scanning period when the display device operates in the first mode (normal mode).

Further, the touch controller is configured to generate touch driving signals only in the H-blank periods both when the display device operates in the first mode (normal mode) and when the display device operates in the second mode (PSR mode).

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the H-blank periods both in the normal mode and the PSR mode to perform the touch detection, thereby making it possible to perform the touch detection in a period during which display noise is reduced. Therefore, it is possible to further improve the sensitivity of the touch detection.

### Eleventh Exemplary Embodiment

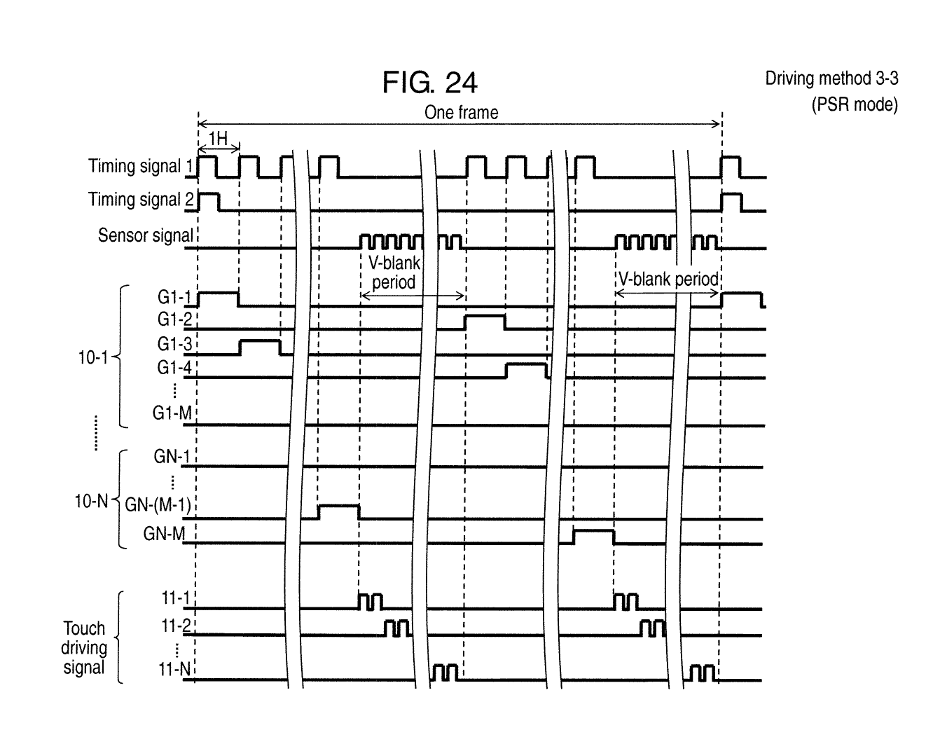

Next, an operation when a display device is driven by driving method 3-3 will be described with reference to FIG. 24.

The driving method in the present exemplary embodiment illustrated in FIG. 24 is substantially the same as driving method 3-1 described in the third exemplary embodiment excepting the following points and is therefore referred to as driving method 3-3. Specifically, in driving method 3-3, the display device is interlace-driven in a PSR mode. Further, in driving method 3-3, a V-blank period is provided at the last of each field in the PSR mode. A length of the V-blank period in the PSR mode is substantially equal to a length of a V-blank period in a normal mode. Therefore, a number of sensor signals generated during the V-blank period in the PSR mode may be equal to a number of sensor signals generated during the V-blank period in the normal mode.

[11-1. Configuration]

The display device in the eleventh exemplary embodiment has substantially the same configuration as the configuration of display device 100 described in the first exemplary embodiment. Therefore, description of the configuration of the display device in the eleventh exemplary embodiment will be omitted. Further, the operation mode of the display device is determined by the touch controller based on the PSR mode signal in the same manner as in the first exemplary embodiment. Therefore, description of this determination will be omitted.

[11-2. Operation]

FIG. 24 is a timing chart of scanning signals and touch driving signals in the PSR mode of driving method 3-3 in the eleventh exemplary embodiment.

An operation in the normal mode of driving method 3-3 is substantially the same as the operation in the normal mode of driving method 3-1 described in the third exemplary embodiment. Therefore, description of the operation in the normal mode of driving method 3-3 will be omitted.

An operation itself of the interlace drive illustrated in FIG. 24 is substantially the same as the operation of the interlace drive described in the ninth exemplary embodiment in which the second field in which scanning signals are applied to scanning signal lines 10 in the even-numbered row is generated after the first field in which scanning signals are applied to scanning signal lines 10 in the odd-numbered row. Therefore, the operation of the interlace drive illustrated in FIG. 24 will be omitted. In an example illustrated in FIG. 24, the display device operates at a frame frequency of 60 Hz in the normal mode and operates at a field frequency of 60 Hz in the PSR mode. Therefore, an operation in the PSR mode corresponds to 30 Hz when converted into a frame frequency.

In the present exemplary embodiment, a V-blank period exists after generation of the last scanning signal in one frame (a scanning signal applied to scanning signal line GN-M, for example) in the normal mode. On the other hand, in the PSR mode, V-blank periods are provided after generation of the last scanning signal in a first field in which scanning signal lines 10 in the odd-numbered row are scanned (a scanning signal applied to scanning signal line GN-(M−1), for example) and after generation of the last scanning signal in a second field in which scanning signal lines 10 in the even-numbered row are scanned (a scanning signal applied to scanning signal line GN-M, for example).

Sensor control circuit 13 determines the operation mode of the display device based on the PSR mode signal.

Sensor control circuit 13 generates sensor signal in each of the V-blank periods. In the PSR mode, sensor control circuit 13 generates sensor signal in the V-blank period after the generation of the last scanning signal in the first field in which scanning signal lines 10 in the odd-numbered row are scanned and generates sensor signal in the V-blank period after the generation of the last scanning signal in the second field in which scanning signal lines 10 in the even-numbered row are scanned. Sensor driving circuit 26 applies touch driving signals to driving electrodes 11 in each of the V-blank periods in response to the sensor signal input from sensor control circuit 13.

As described above, the frame frequency in the normal mode and the field frequency in the PSR mode are substantially equal to each other. Therefore, in the present exemplary embodiment, timing of generating sensor signal and a number of sensor signals to be generated (a number of sensor signals generated during the V-blank period in one frame in the normal mode and a number of sensor signals generated during the V-blank period in one field in the PSR mode) are each substantially the same between the normal mode and the PSR mode.

Accordingly, in the PSR mode, the scanning for one screen for touch detection can be performed in each of the first and second fields which constitute one frame in the same manner as in one frame period in the normal mode. As a result, the report rate of the touch panel in the PSR mode and the report rate of the touch panel in the normal mode can be made substantially equal to each other.

[11-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

Further, the display device is configured to operate so as to apply scanning signals non-sequentially to scanning signal lines 10 (operates in the interlace drive, for example) in a second mode (PSR mode) in which a number of V-blank periods generated in one frame is larger than a number of V-blank periods generated in one frame when the display device operates in a first mode (normal mode). Further, the touch controller is configured to generate touch driving signals only in the V-blank periods both when the display device operates in the first mode (normal mode) and when the display device operates in the second mode (PSR mode).

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the V-blank periods both in the normal mode and the PSR mode to perform the touch detection, thereby making it possible to perform the touch detection in a period during which display noise is reduced. Therefore, it is possible to further improve the sensitivity of the touch detection.

### Twelfth Exemplary Embodiment

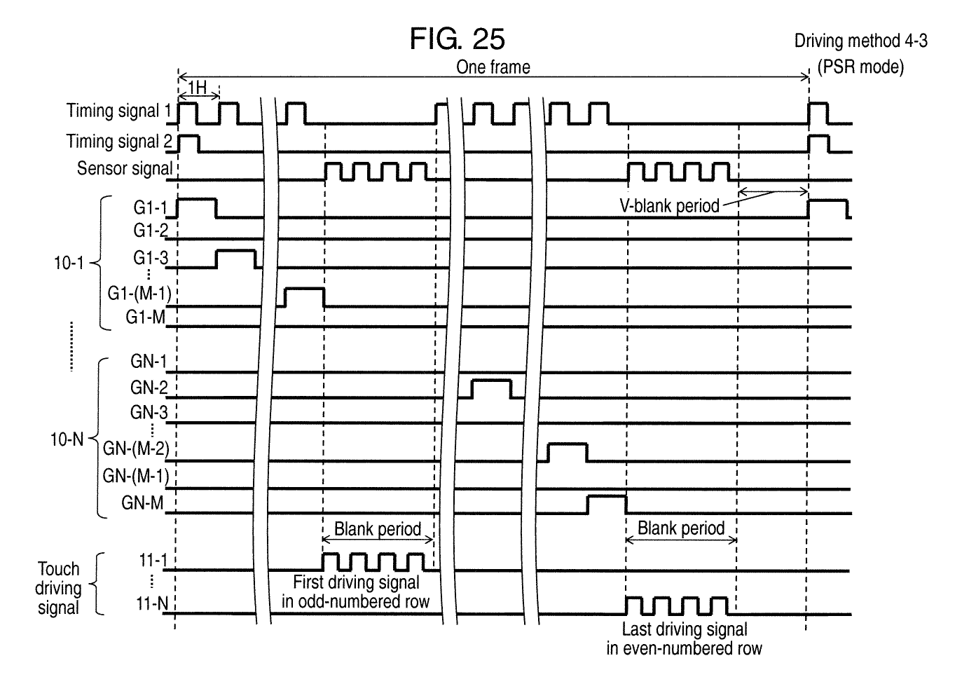

Next, an operation when a display device is driven by driving method 4-3 will be described with reference to FIG. 25.

The driving method in the present exemplary embodiment illustrated in FIG. 25 is substantially the same as driving method 4-1 described in the fourth exemplary embodiment excepting the following points and is therefore referred to as driving method 4-3. Specifically, in driving method 4-3, a display device is interlace-driven in a PSR mode. Further, in driving method 4-3, a number of blank periods generated in one field period in the PSR mode is made substantially equal to a number of blank periods generated in one frame in a normal mode. Therefore, it is not necessary to generate a sensor signal in a V-blank period in the PSR mode.

[12-1. Configuration]

The display device in the twelfth exemplary embodiment has substantially the same configuration as the configuration of display device 100 described in the first exemplary embodiment. Therefore, description of the configuration of the display device in the twelfth exemplary embodiment will be omitted. Further, the operation mode of the display device is determined by the touch controller based on the PSR mode signal in the same manner as in the first exemplary embodiment.

Therefore, description of this determination will be omitted.

[12-2. Operation]

FIG. 25 is a timing chart of scanning signals and touch driving signals in the PSR mode of driving method 4-3 in the twelfth exemplary embodiment.

An operation in the normal mode of driving method 4-3 is substantially the same as the operation in the normal mode of driving method 4-1 described in the fourth exemplary embodiment. Therefore, description of the operation in the normal mode of driving method 4-3 will be omitted.

An operation itself of the interlace drive illustrated in FIG. 25 is substantially the same as the operation of the interlace drive described in the ninth exemplary embodiment in which one frame is composed of the first field in which scanning signals are applied to scanning signal lines 10 in the odd-numbered row and the second field in which scanning signals are applied to scanning signal lines 10 in the even-numbered row. Therefore, the operation itself of the interlace drive illustrated in FIG. 25 will be omitted. In an example illustrated in FIG. 25, the display device operates at a frame frequency of 60 Hz in the normal mode and operates at a field frequency of 60 Hz in the PSR mode. Therefore, an operation in the PSR mode corresponds to 30 Hz when converted into a frame frequency.

In the PSR mode of driving method 4-3, blank periods are each provided when scanning signals are applied to a predetermined number of scanning signal lines 10. In the example illustrated in FIG. 25, the predetermined number is half a number of scanning signal lines 10 that constitute one line block (M/2, for example). Specifically, in a first field in which scanning signals are applied to scanning signal lines 10 in the odd-numbered row, a blank period is provided immediately after each line block scanning period finishes in the following manner. For example, first a blank period is provided after scanning signals are sequentially applied to scanning signal lines G1-1, G1-3, . . . , G1-(M−1) in the odd-numbered row among scanning signal lines 10 that constitutes line block 10-1. Then, a blank period is provided after scanning signals are sequentially applied to scanning signal lines G2-1, G2-3, G2-(M−1) in the odd-numbered row among scanning signal lines 10 that constitutes line block 10-2. Although not illustrated, in a second field in which scanning signals are applied to scanning signal lines 10 in the even-numbered row, a blank period is provided immediately after each line block scanning period finishes in the following manner. For example, first, a blank period is provided after scanning signals are sequentially applied to scanning signal lines G1-2, G1-4, . . . , G1-M in the even-numbered row among scanning signal lines 10 that constitutes line block 10-1. Then, a blank period is provided after scanning signals are sequentially applied to scanning signal lines G2-2, G2-4, . . . , G2-M in the even-numbered row among scanning signal lines 10 that constitutes line block 10-2. Then, a next line block scanning period is started after the blank period.

As a result, in driving method 4-3, a number of blank periods generated in each field in the PSR mode can be made equal to a number of blank periods generated in each frame in the normal mode.

Further, in driving method 4-3, the predetermined number (M/2, for example) in the PSR mode is half a predetermined number (M, for example) in the normal mode. Therefore, a length of each line block scanning period in the PSR mode is substantially half a length of each line block scanning period in the normal mode. Accordingly, a length of each blank period in the PSR mode can be set equal to or more than a length of each blank period in the normal mode. In driving method 4-3, sensor control circuit 13 generates sensor signal in the blank periods. Therefore, sensor control circuit 13 can set a number of sensor signals generated in each blank period in the PSR mode equal to or more than a number of sensor signals generated in each blank period in the normal mode. Therefore, in driving method 4-3, it is possible to maintain the report rate of the touch panel and the sensitivity of touch detection in the PSR mode respectively equal to the report rate of the touch panel and the sensitivity of touch detection in the normal mode without generating a sensor signal in the V-blank period. Because the predetermined number in the normal mode has been described in the fourth exemplary embodiment, description of the predetermined number in the normal mode will be omitted.

In this manner, in driving method 4-3, the blank periods are provided for the respective line block scanning periods both in the first field in which scanning signal lines 10 in the odd-numbered row are scanned and the second field in which scanning signal lines 10 in the even-numbered row are scanned in the PSR mode.

Sensor control circuit 13 determines the operation mode of the display device based on the PSR mode signal.

In driving method 4-3, sensor control circuit 13 generates sensor signal in the blank periods which are provided for the respective line block scanning periods both in the normal mode and the PSR mode. In an example illustrated in FIG. 25, because the blank periods are provided for the respective line block scanning periods, the number of blank periods generated in one field in the PSR mode is equal to the number of blank periods generated in one frame in the normal mode. Further, in the PSR mode, one frame is composed of the first field in which scanning signal lines 10 in the odd-numbered row are scanned and the second field in which scanning signal lines 10 in the even-numbered row are scanned. Therefore, the number of blank periods generated in one frame in the PSR mode is twice the number of blank periods generated in one frame in the normal mode.

As described above, the frame frequency in the normal mode and the field frequency in the PSR mode are substantially equal to each other. Therefore, in the present exemplary embodiment, timing of generating sensor signal and the number of sensor signals to be generated are each substantially the same between the normal mode and the PSR mode.

Accordingly, in the PSR mode, the scanning for one screen for touch detection can be performed in each of the first and second fields which constitute one frame in the same manner as in one frame period in the normal mode. As a result, the report rate of the touch panel in the PSR mode and the report rate of the touch panel in the normal mode can be made substantially equal to each other.

The number of blank periods generated in one frame in the PSR mode may be set comparable to the number of blank periods generated in one frame in the normal mode. In this case, the V-blank period may be made longer by an amount corresponding to a decrease in the number of blank periods, and a sensor signal may be generated in the V-blank period to apply a touch driving signal to driving electrode 11.

[12-3. Effect]

As described above, in the input device in the present exemplary embodiment, the touch controller is configured to determine the operation mode of the display device based on the PSR mode signal in the same manner as in the first exemplary embodiment. Moreover, the signal control device of the display device is configured to generate the PSR mode signal which gives the touch controller notice of the operation mode of the display device in the same manner as in the first exemplary embodiment.

Further, the display device is configured to operate so as to apply scanning signals non-sequentially to scanning signal lines 10 (operates in the interlace drive, for example) in a second mode (PSR mode), and configured to operate with the blank periods each provided when scanning signals are applied to the predetermined number of scanning signal lines 10 both in the first mode (normal mode) and the second mode (PSR mode). Further, the number of blank periods generated in one frame period when the display device operates in the second mode (PSR mode) is set to be larger than the number of blank periods generated in one frame period when the display device operates in the first mode (normal mode). The touch controller is configured to generate touch driving signals only in the blank periods both when the display device operates in the first mode (normal mode) and when the display device operates in the second mode (PSR mode).

As a result, even when the display device has shifted from the normal mode to the PSR mode and operates at a lower frame rate than the normal mode, it is possible to maintain the report rate of the touch panel substantially equal to the report rate in the normal mode to thereby prevent a reduction in the accuracy of detection during the touch operation.

Further, in the input device in the present exemplary embodiment, touch driving signals are generated only in the blank periods both in the normal mode and the PSR mode to perform the touch detection, thereby making it possible to perform the touch detection in a period during which display noise is reduced. Therefore, it is possible to further improve the sensitivity of the touch detection.

### Thirteenth Exemplary Embodiment

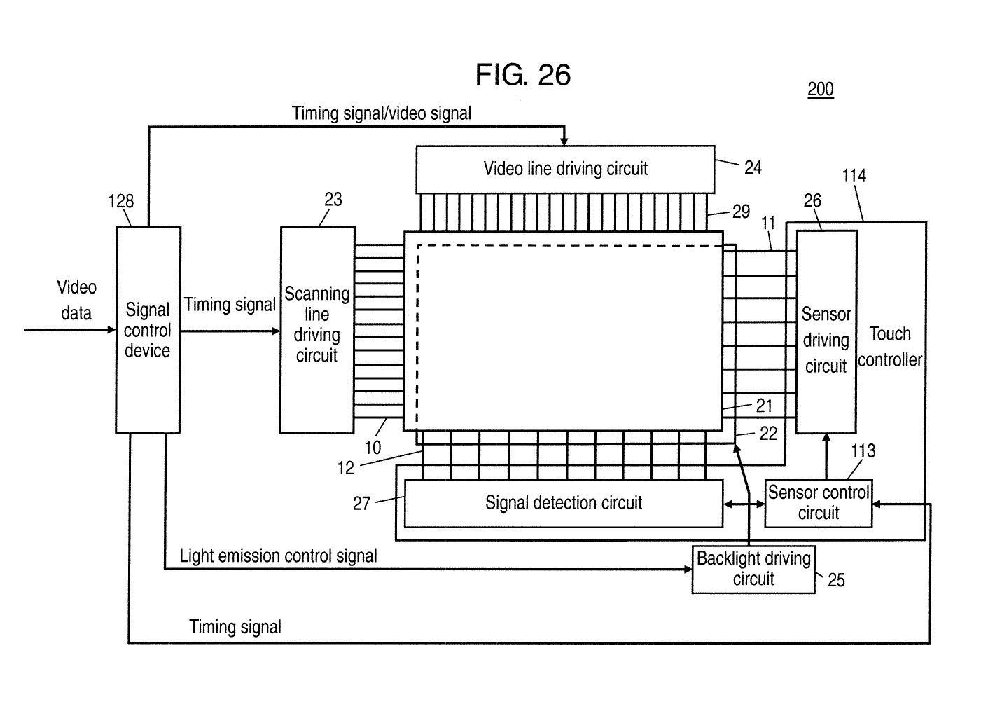

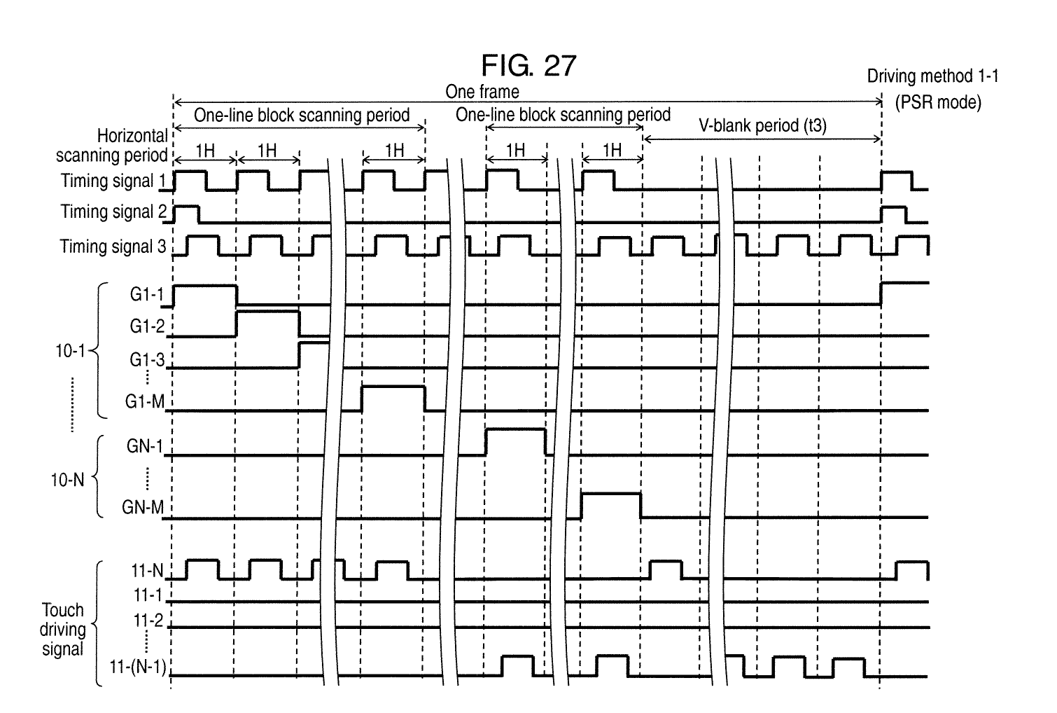

Next, a thirteenth exemplary embodiment will be described with reference to FIGS. 26 and 27.

According to the configurations described in the first through twelfth exemplary embodiments, signal control device 28 of display device 100 outputs the PSR mode signal, and sensor control circuit 13 of touch controller 14 determines the operation mode of display device 100 based on the PSR mode signal. In this case, sensor control circuit 13 generates the sensor signal based on the result of the determination and timing signals 1 and 2 output from the signal control device 28, and sensor driving circuit 26 applies the touch driving signals to driving electrodes 11 based on the sensor signal.

However, the present disclosure is not limited at all to these configurations. For example, the signal control device of the display device may generate signals corresponding to the sensor signal generated by sensor control circuit 13. An example of this configuration will be described in the present exemplary embodiment.

[13-1. Configuration]

FIG. 26 is a block diagram illustrating an entire configuration of display device 200 having a touch sensor function in the thirteenth exemplary embodiment.

As illustrated in FIG. 26, display device 200 includes liquid crystal panel 21, backlight unit 22, scanning line driving circuit 23, video line driving circuit 24, backlight driving circuit 25, signal control device 128, and touch controller 114. Touch controller 114 is provided with sensor control circuit 113, sensor driving circuit 26, and signal detection circuit 27. The input device according to the present exemplary embodiment is configured to include driving electrodes 11, detection electrodes 12, and touch controller 114 similarly to the first through twelfth exemplary embodiments. The basic operation performed by the input device is substantially similar to the basic operation of the input device described in the first through twelfth exemplary embodiments.

According to the present exemplary embodiment, circuit blocks performing substantially the same operations as those of the respective circuit blocks described with reference to FIG. 1 have been given similar reference numerals, and the same explanation is not repeated.

Display device 200 according to the present exemplary embodiment performs substantially the same operations as those of display device 100 described in the first through twelfth exemplary embodiments. However, the operations of signal control device 128 and touch controller 114 (sensor control circuit 113) include operations different from the operations of signal control device 28 and touch controller 14 (sensor control circuit 13) described in the first through twelfth exemplary embodiments. These different operations are described hereinbelow.

According to the first through twelfth exemplary embodiments, signal control device 28 generates the PSR mode signal for giving sensor control circuit 13 notice of the operation mode of display device 100. Then, sensor control circuit 13 generates the sensor signal in accordance with the operation mode of display device 100.

Display device 200 according to the present exemplary embodiment is configured such that signal control device 128 generates third timing signal (hereinafter referred to as “timing signal 3”) corresponding to the sensor signal described in the first through twelfth exemplary embodiments. In this case, sensor control circuit 113 need not generate the sensor signal. Accordingly, signal control device 128 need not give sensor control circuit 113 notice of the operation mode of display device 200, and therefore does not output the PSR mode signal.

Timing signals 1 and 2 described in the first through twelfth exemplary embodiments are generated by signal control device 128 similarly to the case of signal control device 28, and supplied to the respective circuits.

Timing signal 3 is input from signal control device 128 to sensor control circuit 113 together with timing signals 1 and 2. Timing signal 3 is input to sensor driving circuit 26 via sensor control circuit 113. Sensor driving circuit 26 applies touch driving signals to driving electrodes 11 based on timing signal 3.

Timing signal 3 is signal substantially similar to the sensor signal described in the first through twelfth exemplary embodiments, and therefore explanation of timing signal 3 is omitted. In addition, sensor driving circuit 26 of touch controller 114 to which timing signal 3 is input performs substantially the same operations as those of sensor driving circuit 26 described in the first through twelfth exemplary embodiments, and therefore explanation of sensor driving circuit 26 is omitted.

[13-2. Operation]

An example of operation of display device 200 according to the present exemplary embodiment is hereinafter described with reference to FIG. 27.

Display device 200 performs substantially the same operations as the respective operations of display device 100 described in the first through twelfth exemplary embodiments. Shown herein as an example is a timing chart exhibited when display device 200 operates in the PSR mode of driving method 1-1 described in the first exemplary embodiment.

FIG. 27 is a timing chart in the PSR mode of driving method 1-1 in the thirteenth exemplary embodiment.

The timing chart illustrated in FIG. 27 is substantially similar to the timing chart in the PSR mode of driving method 1-1 illustrated in FIG. 9, and therefore the same explanation is not repeated herein. However, the timing chart in the present exemplary embodiment is different from the timing chart illustrated in FIG. 9 in that sensor control circuit 113 does not generate the sensor signal, but that signal control device 128 generates timing signal 3 substantially similar to the sensor signal, and inputs generated timing signal 3 to sensor driving circuit 26.

[13-3. Effect]

As described above, according to display device 200 in the present exemplary embodiment, signal control device 128 generates timing signal 3 corresponding to the sensor signal described in the first through twelfth exemplary embodiments.

Even in the case of display device 200 thus configured, touch detection is allowed with substantially the same accuracy as that of touch detection described in the first through twelfth exemplary embodiments, and therefore substantially the same effects as the effects described in the first through twelfth exemplary embodiments can be offered.

Signal control device 128 may be configured to output timing signal 3 constituted of the same signal as timing signal 1 in the normal mode. In addition, signal control device 128 may be configured to output timing signal 3 when the period in which timing signal 1 is not outputted exceeds a predetermined period during the PSR mode.

### Other Exemplary Embodiments

As described above, the first to thirteenth exemplary embodiments have been described as examples of the technique disclosed in the present application. However, the technique in the present disclosure is not limited to these exemplary embodiments, and can also be applied to the exemplary embodiments after modification, replacement, addition, omission or the like is performed thereon. Elements described in the first to thirteenth exemplary embodiments can also be combined to constitute a new exemplary embodiment.

Hereinbelow, other exemplary embodiments will be described as examples.

In the first to fourth exemplary embodiments described in the present disclosure, no timing signal 1 is output from signal control device 28 during the V-blank period from when the last scanning signal (a scanning signal applied to scanning signal line GN-M, for example) is output from scanning line driving circuit 23 until when a next frame is started. However, signal control device 28 may continuously output timing signal 1 at predetermined timing. Further, after the output of the last scanning signal, the predetermined timing may change. In this case, sensor control circuit 13 can recognize which scanning signal is the last scanning signal by counting a number of timing signals 1. Further, when timing signal 2 is input, sensor control circuit 13 may reset the count.

Also in the above case, in the first to fourth exemplary embodiments, when sensor control circuit 13 determines that the operation mode of display device has shifted to the PSR mode based on the PSR mode signal, touch controller 14 generates touch driving signals in the V-blank period as described above. Therefore, the touch panel can continuously perform touch detection also in the V-blank period. Thus, the report rate of the touch panel in the PSR mode is maintained at a similar level as the report rate in the normal mode. As a result, a reduction in the temporal resolution of touch detection in the PSR mode is prevented.

In each of the first to thirteenth exemplary embodiments, there has been described the example in which the display device is driven either in the first mode as the normal mode or the second mode as the PSR mode. However, the display device may be driven in a mode other than the first and second modes.

In each of the first to thirteenth exemplary embodiments, there has been described the example in which one detection circuit is provided in one detection electrode 12 to configure signal detection circuit 27. However, for example, one detection circuit may be provided in a group of a plurality of detection electrodes 12 to configure signal detection circuit 27. In this case, detection electrodes 12 may monitor detection signals Rxv by time division on a plurality of pulse voltages applied to driving electrodes 11 to detect detection signals Rxv.

A number of pulses that are successively applied at one time to driving electrodes 11 is not limited to one or two, and may be equal to or more than three.

In the first to thirteenth exemplary embodiments, each of a number of timing signals 1, a number of timing signals 2, and a number of sensor signals means a number of pulses of each signals.

In FIG. 14, FIG. 15, FIG. 18, FIG. 20, FIG. 21, FIG. 24, FIG. 25, and the like, the sensor signal and the touch driving signal each having a relatively narrow pulse width have been illustrated. However, such illustration has been made merely because of a space matter. Desirably, each pulse width is appropriately set depending on, for example, specifications of the display device and the panel.

The values described in the above exemplary embodiments, for example, the values of the frame frequency and the like are merely examples. Therefore, the present disclosure is not limited at all to these values.

The present disclosure can be applied in an input device that is provided in a display device that performs PSR system drive. Specifically, the present disclosure can be applied, for example, to a liquid crystal television and a liquid crystal display both equipped with a touch panel, a computer and an input terminal both equipped with an integrated display, a tablet terminal, a smart phone, and various home electric appliances equipped with a touch panel. The present disclosure can also be applied to various electrical apparatuses equipped with a touch panel and a display device integrated therewith.

What is claimed is:

1. A display device configured to operate in any of a plurality of operation modes including a first mode in which the display device operates at a first frame frequency and a second mode in which the display device operates at a second frame frequency lower than the first frame frequency, and to generate a mode signal giving notice of the operation mode, the display device comprising:
a plurality of scanning signal lines; and
an input device configured to detect a contact position of a user,
wherein the input device includes
a plurality of driving electrodes;
a plurality of detection electrodes arranged to intersect the driving electrodes; and
a touch controller connected to the detection electrodes, the touch controller being configured to detect a detection signal from the detection electrodes so as to detect the contact position, configured to determine the operation mode of the display device based on the mode signal, configured to generate touch driving signals based on a result of the determination, and configured to apply the generated touch driving signals to the driving electrodes.

2. The display device according to claim 1, wherein
the display device is configured so that scanning signals are generated based on first timing signal generated depending on the operation mode and a second timing signal generated once per one frame, and configured so that when the display device operates in the second mode, the first timing signal is not generated in a V-blank period in which the scanning signals are not applied to the scanning signal lines, and
the touch controller is configured to generate the touch driving signals based on the first timing signal when the touch controller determines based on the mode signal that the display device operates in the first mode, and configured to generate the touch driving signals based on the first timing signal and also in the V-blank period in which the first timing signal is not generated when the touch controller determines based on the mode signal that the display device operates in the second mode.

3. The display device according to claim 2, wherein
the display device is configured to operate with an H-blank period in which no scanning signal is applied to scanning signal lines, the H-blank period being provided in one horizontal scanning line, and
the touch controller is configured to generate the touch driving signals only in the H-blank period when the touch controller determines that the display device operates in the first mode, and configured to generate the touch driving signals in the H-blank period and the V-blank period when the touch controller determines that the display device operates in the second mode.

4. The display device according to claim 1, wherein the touch controller is configured to generate the touch driving signals only in a V-blank period and configured to generate more touch driving signals during the V-blank period when the display device operates in the second mode than during the V-blank period when the display device operates in the first mode.

5. The display device according to claim 1, wherein
the display device is configured to operate with blank periods each provided when scanning signals are applied to a predetermined number of scanning signal lines, and
the touch controller is configured to generate the touch driving signals only in the blank period when the touch controller determines based on the mode signal that the display device operates in the first mode, and configured to generate the touch driving signals in the blank period and a V-blank period when the touch controller determines based on the mode signal that the display device operates in the second mode.

6. The display device according to claim 1, wherein the touch controller is configured to generate more touch driving signals during one horizontal scanning period when the touch controller determines based on the mode signal that the display device operates in the second mode than during one horizontal scanning period when the display device operates in the first mode.

7. The display device according to claim 6, wherein the touch controller is configured to generate the touch driving signals only in an H-blank period both when the display device operates in the first mode and when the display device operates in the second mode.

8. The display device according to claim 1, wherein the touch controller is configured to generate the touch driving signals only in a V-blank period when the touch controller determines based on the mode signal that the display device operates in the first mode, and configured to generate the touch driving signals in an H-blank period and the V-blank period when the touch controller determines based on the mode signal that the display device operates in the second mode.

9. The display device according to claim 1, wherein
the display device is configured to operate with blank periods each provided when scanning signals are applied to a predetermined number of scanning signal lines, and
the touch controller is configured to generate the touch driving signals only in the blank period when the touch controller determines based on the mode signal that the display device operates in the first mode, and configured to generate the touch driving signals in the blank period and an H-blank period when the touch controller determines based on the mode signal that the display device operates in the second mode.

10. The display device according to claim 1, wherein
the display device is configured so as to apply scanning signals non-sequentially to scanning signal lines in the second mode, and
the touch controller is configured to generate more touch driving signals during one horizontal scanning period when the touch controller determines based on the mode signal that the display device operates in the second mode than during one horizontal scanning period when the display device operates in the first mode.

11. The display device according to claim 10, wherein the touch controller is configured to generate the touch driving signals only in an H-blank period both when the display device operates in the first mode and when the display device operates in the second mode.

12. The display device according to claim 1, wherein
the display device is configured to operate so as to apply scanning signals non-sequentially to scanning signal lines in the second mode in which a number of V-blank periods generated in one frame is larger than a number of V-blank periods generated in one frame when the display device operates in the first mode, and
the touch controller is configured to generate the touch driving signals only in the V-blank period both when the display device operates in the first mode and when the display deice operates in the second mode.

13. The display device according to claim 1, wherein
the display device is configured to operate so as to apply scanning signals non-sequentially to scanning signal lines in the second mode and configured to operate with blank periods each provided when scanning signals are applied to a predetermined number of scanning signal lines both in the first mode and the second mode so that a number of the blank periods generated in one frame period when the display device operates in the second mode is larger than a number of the blank periods generated in one frame period when the display device operates in the first mode, and
the touch controller is configured to generate the touch driving signals only in the blank period both when the display device operates in the first mode and when the display device operates in the second mode.

14. An input device provided in a display device and configured to detect a contact position of a user, the display device being configured to operate in any of a plurality of operation modes including a first mode in which the display device operates at a first frame frequency and a second mode in which the display device operates at a second frame frequency lower than the first frame frequency, and configured to generate a mode signal giving notice of the operation mode, the input device comprising:
a plurality of driving electrodes,
a plurality of detection electrodes arranged to intersect the driving electrodes, and
a touch controller connected to the detection electrodes, the touch controller being configured to detect a detection signal from the detection electrodes so as to detect the contact position, configured to determine the operation mode of the display device based on the mode signal, configured to generate touch driving signals based on a result of the determination, and configured to apply the generated touch driving signals to the driving electrodes.
